(19) United States
(12) Patent Application Publication
(10) Pub. No.: US 2020/0387237 A1
(43) Pub. Date: Dec. 10, 2020

(54) Instrument with Passive Tip

(71) Applicant: Rapt IP Limited, Mriehel (MT)

(72) Inventor: Owen Drumm, Dublin (IE)

(21) Appl. No.: 16/898,418

(22) Filed: Jun. 10, 2020

Related U.S. Application Data
(60) Provisional application No. 62/859,687, filed on Jun. 10, 2019.

(51) Int. Cl. G06F 3/03; G06F 3/042

(52) U.S. Cl. CPC G06F 3/0325; G06F 2203/04109; G06F 3/0421

(57) ABSTRACT

An instrument with a passive tip is used with a touch-sensitive surface. The touch-sensitive surface has emitters that generate optical beams that propagate along the surface to detectors. The passive instrument includes a body and a tip. The tip is coupled to the body and configured to interact with a first optical beam incident on the tip at a first angle differently than a second optical beam incident on the tip at a second angle such that a controller associated with the touch-sensitive surface can distinguish between the tip and a different tip based on properties of the first and second optical beams detected by the detectors.

### CROSS REFERENCE TO RELATED APPLICATIONS

This application claims the benefit of priority to U.S. Provisional Patent Application No. 62/859,687, “Passive Instrument with Identification and Other Attributes,” filed on Jun. 10, 2019, which is incorporated by reference.

### BACKGROUND

### 1. Field of Art

This description generally relates to passive a stylus interacting with a surface of touch-sensitive device, and specifically to a stylus configured to disturb optical beams in different manners based on an orientation stylus.

### 2. Description of the Related Art

Touch-sensitive displays for interacting with computing devices are becoming more common. A number of different technologies exist for implementing touch-sensitive displays and other touch-sensitive devices. Examples of these techniques include, for example, resistive touch screens, surface acoustic wave touch screens, capacitive touch screens and certain types of optical touch screens.

While touch objects are generally fingers, solutions exist to support detection of other touch objects types, such as styli. However, typical passive styli only offer a single operating mode when interacting with the touch system. This can limit the functionality of the stylus and the touch system.

### SUMMARY

An optical touch-sensitive device may determine the locations of touch events. The optical touch-sensitive device includes multiple emitters and detectors. Each emitter produces optical radiant energy which is received by the detectors. In some embodiments, the optical emitters are frequency or code-division multiplexed in a manner so that many optical sources can be received by a detector simultaneously. Alternatively, emitters are time multiplexed and are activated sequentially in a predefined sequence. Touch events disturb the optical energy transfer from emitter to detector. Variations in light transfer resulting from the touch events are captured, and are used to determine the touch events. In one aspect, information indicating which emitter-detector pairs have been disturbed by touch events is received. The light disturbance for each pair is characterized and used to determine the beams attenuation resulting from the touch events.

The emitters and detectors may be interleaved around the periphery of the touch sensitive surface. In other embodiments, the number of emitters and detectors are different and are distributed around the periphery in a defined order. The emitters and detectors may be regularly or irregularly spaced. In some cases, the emitters and/or detectors are located on less than all of the sides (e.g., one side). In some cases, the emitters and/or detectors are not physically located at the periphery. For example, couplers, such as waveguides, couple beams between the touch surface and the emitters and/or detectors. Reflectors may also be positioned around the periphery to reflect optical beams, causing the path from the emitter to the detector to pass across the surface more than once. For each emitter-detector pair, a beam may be defined by combining light rays propagating from an emitter and a detector. In some implementations, the disturbance of a beam is characterized by its transmission coefficient, and the beam attenuation is determined from the transmission coefficient.

Embodiments relate to a touch-sensitive system including a touch-sensitive surface, one or more emitters, a passive instrument, one or more detectors, and a controller. The one or more emitters are configured to emit optical beams that traverse the touch-sensitive surface. The optical beams include a first beam that traverses the touch-sensitive surface at a first angle and a second beam that traverses the touch-sensitive surface at a second angle. The passive instrument is configured to interact with the first beam differently than the second beam, where the difference in interaction is a function of the first and second angles. The one or more detectors are configured to measure one or more properties of the optical beams after the optical beams have traversed the touch-sensitive surface. The controller is configured to determine differences in the properties of the first and second optical beams relative to a scenario where the passive-instrument is not present. The controller is also configured to identify the passive instrument as being one of a set of possible passive instruments based on the differences in the properties of the first and second optical beams.

In some embodiments, the controller is further configured to determine an orientation of the passive instrument based on the differences in the properties of the first and second optical beams. In some embodiments, the controller is further configured to modify a software parameter based on changes in the orientation of the passive instrument.

In some embodiments, the emitters and detectors are arranged around a periphery of the touch-sensitive surface.

In some embodiments, the touch-sensitive surface is a plane and the first and second angles are in the plane of the touch-sensitive surface

Embodiments relate to a passive instrument for use with a touch-sensitive surface, the touch-sensitive surface having emitters that generate optical beams that propagate along the surface to detectors, the passive instrument including a body and a tip. The body has a first end. The tip is coupled to the first end of the body, and configured to interact with a first optical beam incident on the tip at a first angle differently than a second optical beam incident on the tip at a second angle such that a controller associated with the touch-sensitive surface can distinguish between the tip and a different tip based on properties of the first and second optical beams detected by the detectors.

In some embodiments, the body has a long axis connecting the first end and a second end, the passive instrument further includes the different tip coupled to the second end of the body.

In some embodiments, the tip attenuates the first beam by a greater amount than the second beam. In some embodiments, the body has a long axis connecting the first end and a second end, and the tip has an elliptical cross-section in a plane perpendicular to the long axis. In some embodiments, the tip includes an aperture configured to allow a portion of the second optical beam to pass through the tip without interacting with the tip. In some embodiments, the tip has a cross-section in a plane perpendicular to the long axis of the body. The cross-section has a first axis and a second axis, and the cross-section is narrower along the second axis than the first axis. In some embodiments, the tip includes a plurality of vanes arranged along the first axis. The vanes have a wide axis and a narrow axis in the plane perpendicular to the long axis of the body, where the wide axis is parallel to the second axis. In some embodiments, the tip includes a plurality of vanes arranged along the first axis. The vanes have a wide axis and a narrow axis in the plane perpendicular to the long axis of the body, where the wide axis is at an angle between ten and eighty degrees relative to the second axis. In some embodiments, the tip includes a pair of layers aligned with the first axis and separated along the second axis. Each of the pair of layers including a pattern of optical structures that interact with incident beams. An alignment between the patterns of optical structures of the layers causes the tip to interact with the first beam differently than the second beam. In some embodiments, the passive instrument further includes a mechanical control mounted on the body. The mechanical control, when actuated, causes the alignment between the patterns of optical structures of the layers to change.

In some embodiments, the tip includes a pattern of optical elements that cause the tip to interact with the first beam differently than the second beam. The passive instrument further includes a mechanical control mounted on the body and a baffle. The baffle is configured to move to at least partially obscure the pattern of optical elements responsive to actuation of the mechanical control.

In some embodiments, the tip includes a pattern of optical elements that cause the tip to interact with the first beam differently than the second beam. The passive instrument further includes a sliding element configured to obscure the pattern of optical structures when the passive instrument is not in contact with the touch-sensitive surface and reveal at least a portion of the pattern of optical structures when the passive instrument is in contact with the touch-sensitive surface. In some embodiments, a proportion of the pattern of optical structures revealed is responsive to a contact force between the tip and the touch-sensitive surface.

In some embodiments, the tip is configured to diffuse at least some of the optical beams such that an optical intensity measured by some of the detectors increases and the optical intensity measured by others of the detectors decreases relative to the scenario where the passive instrument is not present.

In some embodiments, the tip includes a retroreflective portion configured to reflect incident beams with a range of incidence angles at a predetermined reflected angle.

### BRIEF DESCRIPTION OF DRAWINGS

Embodiments of the present disclosure will now be described, by way of example, with reference to the accompanying drawings.

FIG. 1 is a diagram of an optical touch-sensitive device, according to an embodiment.

FIG. 2 is a flow diagram for determining the characteristics of touch events, according to an embodiment.

FIG. 3A-3F illustrate example mechanisms for a touch interaction with an optical beam, according to some embodiments.

FIG. 4 is a graph of binary and analog touch interactions, according to an embodiment.

FIGS. 5A-5C are top views of differently shaped beam footprints, according to some embodiments.

FIGS. 6A-6B are top views illustrating a touch point travelling through a narrow beam and a wide beam, respectively, according to some embodiments.

FIG. 7 is a graph of the binary and analog responses for the narrow and wide beams of FIG. 6, according to some embodiments.

FIGS. 8A and 8B are top views illustrating active touch area coverage by emitters, according to some embodiments.

FIGS. 8C and 8D are top views illustrating active touch area coverage by detectors, according to some embodiments.

FIG. 8E is a top view illustrating alternating emitters and detectors, according to an embodiment.

FIGS. 9A-9C are top views illustrating beam patterns interrupted by a touch point, from the viewpoint of different beam terminals, according to some embodiments.

FIG. 9D is a top view illustrating estimation of the touch point, based on the interrupted beams of FIGS. 9A-9C and the line images of FIGS. 10A-10C, according to an embodiment.

FIGS. 10A-10C are graphs of line images corresponding to the cases shown in FIGS. 9A-9C, according to some embodiments.

FIG. 11A is a top view illustrating a touch point travelling through two adjacent wide beams, according to an embodiment.

FIG. 11B are graphs of the analog responses for the two wide beams of FIG. 11A, according to some embodiments.

FIG. 11C is a top view illustrating a touch point travelling through many adjacent narrow beams, according to an embodiment.

FIGS. 12A-12E are top views of beam paths illustrating templates for touch events, according to some embodiments.

FIG. 13 is a flow diagram of a multi-pass method for determining touch locations, according to some embodiments.

FIG. 14 shows how warping results in a range of height intervals between the touch surface and the sensing plane, according to an embodiment.

FIG. 15 shows a pen instrument with a solid cylindrical tip and an aperture to encode an angular transmission behavior, according to an embodiment.

FIG. 16 shows an instrument with a blade protrusion tip, according to an embodiment.

FIG. 17 shows sensing beams encountering a pen blade tip, according to an embodiment.

FIG. 18 shows a polar response for an example solid opaque blade tip, according to an embodiment.

FIG. 19 shows a blade with an in-plane reflector which reflects light but preserves the plane of reflection, according to an embodiment.

FIGS. 20, 21, and 22 show various examples of different blade designs with angular coding that have different directional transmission properties, according to some embodiments.

FIG. 23 shows some example blade designs and axes for which the attenuation is lowest for these designs, according to an embodiment.

FIGS. 24A-24C show the polar plots for a few blade designs, according to some embodiments.

FIGS. 25A-25C show spaced layers of opaque, attenuating, diffusing, or reflective material or structures where the combination of layers results in a variation in attenuation with azimuth angle of incident light, according to an embodiment.

FIG. 26 shows a scheme similar to FIGS. 25A-25C except the patterning is present on the surface of a solid optically transmissive material.

FIG. 27 shows how an angular response of a blade can be adjusted mechanically, according to an embodiment.

FIG. 28 shows a button-operated mechanism on a pen instrument that moves a baffle over a patterned area of the tip, according to an embodiment.

FIG. 29 shows a contact force operated mechanism which causes an optically transmissive area on a slider to reveal a pattern when the slider tip is brought into contact with a touch surface, according to an embodiment.

FIG. 30 shows an alternative version of the design in FIG. 29 that has patterning, according to an embodiment.

FIG. 31 shows a cross-section of a blade made from a substantially optically transmissive material, according to an embodiment.

FIG. 32 illustrates an instrument with a circular tip on one end and an elliptical tip on the other, according to an embodiment.

### DETAILED DESCRIPTION

### I. Introduction

A. Device Overview

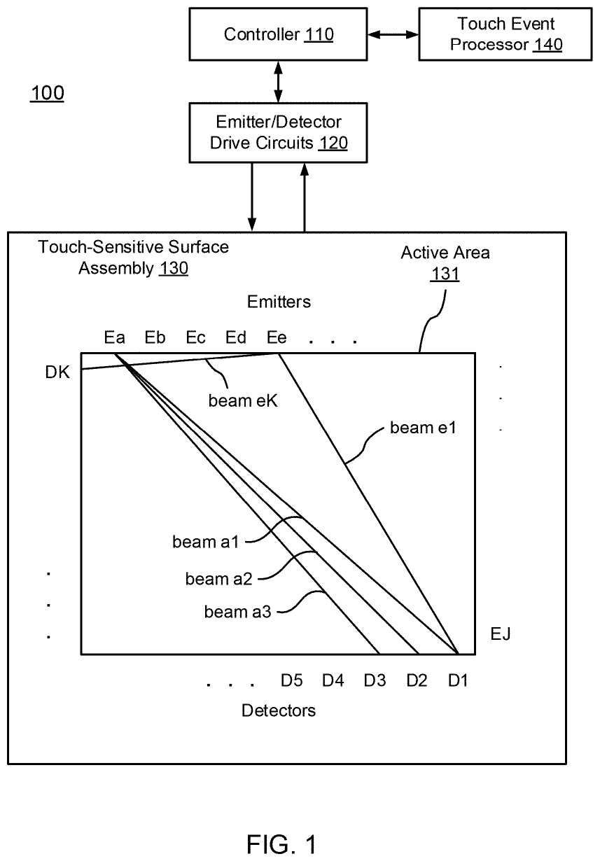

FIG. 1 is a diagram of an optical touch-sensitive device 100 (also referred to as a touch system, touch-sensitive device, or optical touch sensor), according to one embodiment. The optical touch-sensitive device 100 includes a controller 110, emitter/detector drive circuits 120, and a touch-sensitive surface assembly 130. The surface assembly 130 includes a surface 131 over which touch events are to be detected. For convenience, the area defined by surface 131 may sometimes be referred to as the active touch area, touch surface, or active touch surface, even though the surface itself may be an entirely passive structure. The assembly 130 also includes emitters and detectors arranged along the periphery of the active touch surface 131. In this example, there are J emitters labeled as Ea-EJ and K detectors labeled as D1-DK. The device also includes a touch event processor 140, which may be implemented as part of the controller 110 or separately as shown in FIG. 1. A standardized API may be used to communicate with the touch event processor 140, for example between the touch event processor 140 and controller 110, or between the touch event processor 140 and other devices connected to the touch event processor.

The emitter/detector drive circuits 120 serve as an interface between the controller 110 and the emitters Ej and detectors Dk. The emitters produce optical “beams” which are received by the detectors. Preferably, the light produced by one emitter is received by more than one detector, and each detector receives light from more than one emitter. For convenience, “beam” will refer to the light from one emitter to one detector, even though it may be part of a large fan of light that goes to many detectors rather than a separate beam. The beam from emitter Ej to detector Dk will be referred to as beam jk. FIG. 1 expressly labels beams a1, a2, a3, e1 and eK as examples. Touches within the active touch area 131 will disturb certain beams, thus changing what is received at the detectors Dk. Data about these changes is communicated to the touch event processor 140, which analyzes the data to determine the location(s) (and times) of touch events on surface 131.

The emitters and detectors may be interleaved around the periphery of the sensitive surface. In other embodiments, the number of emitters and detectors are different and are distributed around the periphery in any defined order. The emitters and detectors may be regularly or irregularly spaced. In some cases, the emitters and/or detectors may be located on less than all of the sides (e.g., one side). In some embodiments, the emitters and/or detectors are not located around the periphery (e.g., beams are directed to/from the active touch area 131 by optical beam couplers). Reflectors may also be positioned around the periphery to reflect optical beams, causing the path from the emitter to the detector to pass across the surface more than once.

One advantage of an optical approach as shown in FIG. 1 is that this approach scales well to larger screen sizes compared to conventional touch devices that cover an active touch area with sensors, such as resistive and capacitive sensors. Since the emitters and detectors may be positioned around the periphery, increasing the screen size by a linear factor of N means that the periphery also scales by a factor of N compared to N² for conventional touch devices.

B. Process Overview

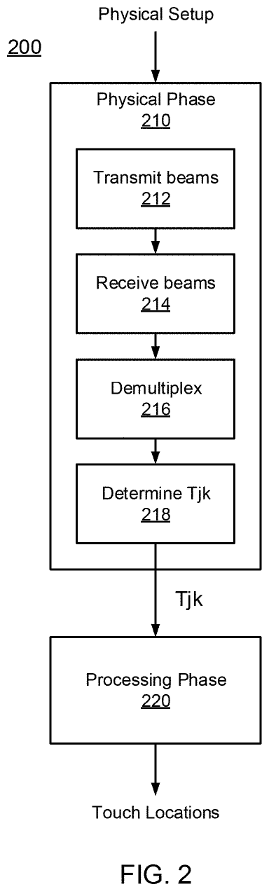

FIG. 2 is a flow diagram for determining the characteristics of touch events, according to an embodiment. This process will be illustrated using the device of FIG. 1. The process 200 is roughly divided into two phases, which will be referred to as a physical phase 210 and a processing phase 220. Conceptually, the dividing line between the two phases is a set of transmission coefficients Tjk (also referred to as transmission values Tjk).

The transmission coefficient Tjk is the transmittance of the optical beam from emitter j to detector k, compared to what would have been transmitted if there was no touch event interacting with the optical beam. In the following examples, we will use a scale of 0 (fully blocked beam) to 1 (fully transmitted beam). Thus, a beam jk that is undisturbed by a touch event has Tjk=1. A beam jk that is fully blocked by a touch event has a Tjk=0. A beam jk that is partially blocked or attenuated by a touch event has 0<Tjk<1. It is possible for Tjk>1, for example depending on the nature of the touch interaction or in cases where light is deflected or scattered to detectors k that it normally would not reach.

The use of this specific measure is purely an example. Other measures can be used. In particular, since we are most interested in interrupted beams, an inverse measure such as (1−Tjk) may be used since it is normally 0. Other examples include measures of absorption, attenuation, reflection, or scattering. In addition, although FIG. 2 is explained using Tjk as the dividing line between the physical phase 210 and the processing phase 220, it is not required that Tjk be expressly calculated. Nor is a clear division between the physical phase 210 and processing phase 220 required.

Returning to FIG. 2, the physical phase 210 is the process of determining the Tjk from the physical setup. The processing phase 220 determines the touch events from the Tjk. The model shown in FIG. 2 is conceptually useful because it somewhat separates the physical setup and underlying physical mechanisms from the subsequent processing.

For example, the physical phase 210 produces transmission coefficients Tjk. Many different physical designs for the touch-sensitive surface assembly 130 are possible, and different design tradeoffs will be considered depending on the end application. For example, the emitters and detectors may be narrower or wider, narrower angle or wider angle, various wavelengths, various powers, coherent or not, etc. As another example, different types of multiplexing may be used to allow beams from multiple emitters to be received by each detector. Several of these physical setups and manners of operation are described below, primarily in Section II.

The interior of block 210 shows one possible implementation of process 210. In this example, emitters transmit 212 beams to multiple detectors. Some of the beams travelling across the touch-sensitive surface are disturbed by touch events. The detectors receive 214 the beams from the emitters in a multiplexed optical form. The received beams are de-multiplexed 216 to distinguish individual beams jk from each other. Transmission coefficients Tjk for each individual beam jk are then determined 218.

The processing phase 220 computes the touch characteristics and can be implemented in many different ways. Candidate touch points, line imaging, location interpolation, touch event templates and multi-pass approaches are all examples of techniques that may be used to compute the touch characteristics (such as touch location and touch strength) as part of the processing phase 220. Several of these are identified in Section III.

### II. Physical Set-Up

The touch-sensitive device 100 may be implemented in a number of different ways. The following are some examples of design variations.

A. Electronics

With respect to electronic aspects, note that FIG. 1 is exemplary and functional in nature. Functions from different boxes in FIG. 1 can be implemented together in the same component.

For example, the controller 110 and touch event processor 140 may be implemented as hardware, software or a combination of the two. They may also be implemented together (e.g., as an SoC with code running on a processor in the SoC) or separately (e.g., the controller as part of an ASIC, and the touch event processor as software running on a separate processor chip that communicates with the ASIC). Example implementations include dedicated hardware (e.g., ASIC or programmed field programmable gate array (FPGA)), and microprocessor or microcontroller (either embedded or standalone) running software code (including firmware). Software implementations can be modified after manufacturing by updating the software.

The emitter/detector drive circuits 120 serve as an interface between the controller 110 and the emitters and detectors. In one implementation, the interface to the controller 110 is at least partly digital in nature. With respect to emitters, the controller 110 may send commands controlling the operation of the emitters. These commands may be instructions, for example a sequence of bits which mean to take certain actions: start/stop transmission of beams, change to a certain pattern or sequence of beams, adjust power, power up/power down circuits. They may also be simpler signals, for example a “beam enable signal,” where the emitters transmit beams when the beam enable signal is high and do not transmit when the beam enable signal is low.

The circuits 120 convert the received instructions into physical signals that drive the emitters. For example, circuit 120 might include some digital logic coupled to digital to analog converters, in order to convert received digital instructions into drive currents for the emitters. The circuit 120 might also include other circuitry used to operate the emitters: modulators to impress electrical modulations onto the optical beams (or onto the electrical signals driving the emitters), control loops and analog feedback from the emitters, for example. The emitters may also send information to the controller, for example providing signals that report on their current status.

With respect to the detectors, the controller 110 may also send commands controlling the operation of the detectors, and the detectors may return signals to the controller. The detectors also transmit information about the beams received by the detectors. For example, the circuits 120 may receive raw or amplified analog signals from the detectors. The circuits then may condition these signals (e.g., noise suppression), convert them from analog to digital form, and perhaps also apply some digital processing (e.g., demodulation).

B. Touch Interactions

Not all touch objects are equally good beam attenuators, as indicated by their transmission coefficient Tjk. Beam attenuation mainly depends on the optical transparency of the object and the volume of the object portion that is interacting with the beam, i.e. the object portion that intersects the beam propagation volume.

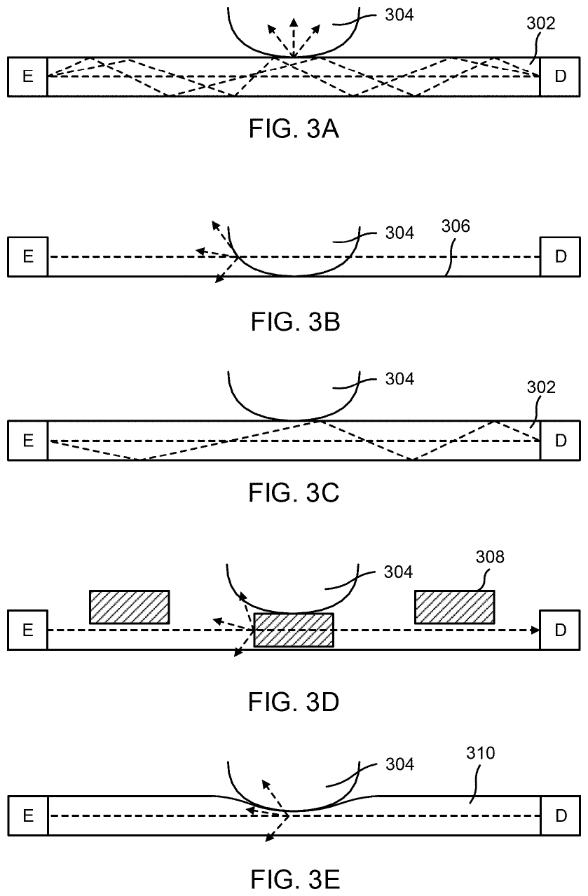

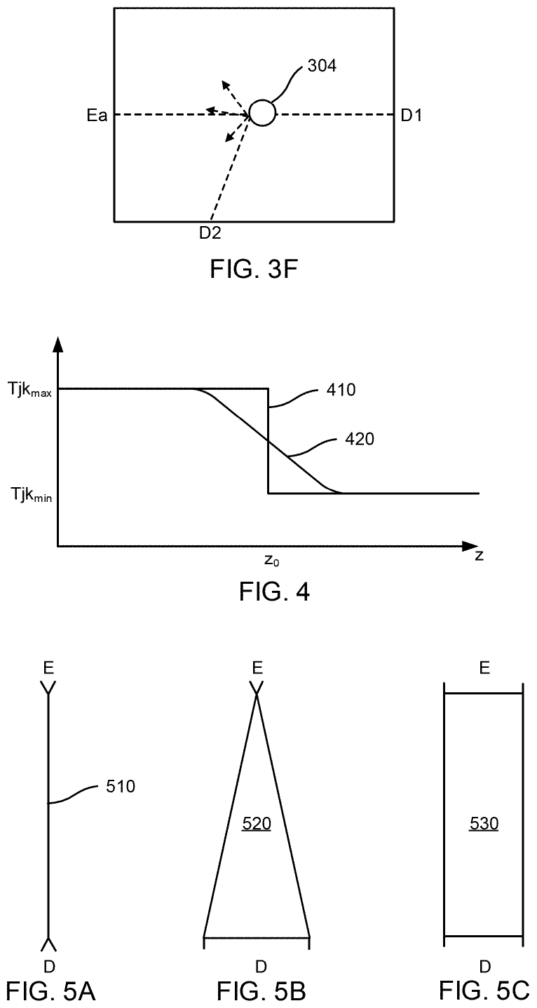

FIGS. 3A-3F illustrate different mechanisms for a touch interaction with an optical beam. FIG. 3A illustrates a mechanism based on frustrated total internal reflection (TIR). The optical beam, shown as a dashed line, travels from emitter E to detector D through an optically transparent planar waveguide 302. The beam is confined to the waveguide 302 by total internal reflection. The waveguide may be constructed of plastic or glass, for example. An object 304, such as a finger or stylus, coming into contact with the transparent waveguide 302, has a higher refractive index than the air normally surrounding the waveguide. Over the area of contact, the increase in the refractive index due to the object disturbs the total internal reflection of the beam within the waveguide. The disruption of total internal reflection increases the light leakage from the waveguide, attenuating any beams passing through the contact area. Correspondingly, removal of the object 304 will stop the attenuation of the beams passing through. Attenuation of the beams passing through the touch point will result in less power at the detectors, from which the reduced transmission coefficients Tjk can be calculated.

The object 304 may disturb the beams if the object 304 is not in direct contact with the surface of the waveguide. If a distance between the object 304 and the surface of the waveguide is less than or equal to the evanescent field of the beams (e.g., 2 μm), the object may disturb the beams and the touch system may determine that a touch event occurred.

FIG. 3B illustrates a mechanism based on beam blockage (also referred to as an “over the surface” (OTS) configuration). Emitters produce beams which are in close proximity to a surface 306. An object 304 coming into contact with the surface 306 will partially or entirely block beams within the contact area. Since the beams propagate over the surface 306, the object 304 may block the beam even if it is not in direct contact with the surface (this may be referred to as a ‘pre-touch’). FIGS. 3A and 3B illustrate two physical mechanisms for touch interactions, but other mechanisms can also be used. For example, the touch interaction may be based on changes in polarization, scattering, or changes in propagation direction or propagation angle (either vertically or horizontally).

For example, FIG. 3C illustrates a different mechanism based on propagation angle. In this example, the optical beam is guided in a waveguide 302 via TIR. The optical beam hits the waveguide-air interface at a certain angle and is reflected back at the same angle. However, the touch 304 changes the angle at which the optical beam is propagating, and may also absorb some of the incident light. In FIG. 3C, the optical beam travels at a steeper angle of propagation after the touch 304. Note that changing the angle of the light may also cause it to fall below the critical angle for total internal reflection, whereby it will leave the waveguide. The detector D has a response that varies as a function of the angle of propagation. The detector D could be more sensitive to the optical beam travelling at the original angle of propagation or it could be less sensitive. Regardless, an optical beam that is disturbed by a touch 304 will produce a different response at detector D.

In FIGS. 3A-3C, the touching object was also the object that interacted with the beam. This will be referred to as a direct interaction. In an indirect interaction, the touching object interacts with an intermediate object, which interacts with the optical beam. FIG. 3D shows an example that uses intermediate blocking structures 308. Normally, these structures 308 do not block the beam. However, in FIG. 3D, object 304 contacts the blocking structure 308, which causes it to partially or entirely block the optical beam. In FIG. 3D, the structures 308 are shown as discrete objects, but they do not have to be so.

In FIG. 3E, the intermediate structure 310 is a compressible, partially transmitting sheet. When there is no touch, the sheet attenuates the beam by a certain amount. In FIG. 3E, the touch 304 compresses the sheet, thus changing the attenuation of the beam. For example, the upper part of the sheet may be more opaque than the lower part, so that compression decreases the transmittance. Alternatively, the sheet may have a certain density of scattering sites. Compression increases the density in the contact area, since the same number of scattering sites occupies a smaller volume, thus decreasing the transmittance. Analogous indirect approaches can also be used for frustrated TIR. Note that this approach could be used to measure contact pressure or touch velocity, based on the degree or rate of compression.

The touch mechanism may also enhance transmission, instead of or in addition to reducing transmission. For example, the touch interaction in FIG. 3E might increase the transmission instead of reducing it. The upper part of the sheet may be more transparent than the lower part, so that compression increases the transmittance.

FIG. 3F shows another example where the transmittance between an emitter and detector increases due to a touch interaction. FIG. 3F is a top view. Emitter Ea normally produces a beam that is received by detector D1. When there is no touch interaction, Ta1=1 and Ta2=0. However, a touch interaction 304 blocks the beam from reaching detector D1 and scatters some of the blocked light to detector D2. Thus, detector D2 receives more light from emitter Ea than it normally would. Accordingly, when there is a touch event 304, Ta1 decreases and Ta2 increases.

For simplicity, in the remainder of this description, the touch mechanism will be assumed to be primarily of a blocking nature, meaning that a beam from an emitter to a detector will be partially or fully blocked by an intervening touch event. This is not required, but it is convenient to illustrate various concepts.

For convenience, the touch interaction mechanism may sometimes be classified as either binary or analog. A binary interaction is one that basically has two possible responses as a function of the touch. Examples includes non-blocking and fully blocking, or non-blocking and 10%+ attenuation, or not frustrated and frustrated TIR. An analog interaction is one that has a “grayscale” response to the touch: non-blocking passing through gradations of partially blocking to blocking. Whether the touch interaction mechanism is binary or analog depends in part on the nature of the interaction between the touch and the beam. It does not depend on the lateral width of the beam (which can also be manipulated to obtain a binary or analog attenuation, as described below), although it might depend on the vertical size of the beam.

FIG. 4 is a graph illustrating a binary touch interaction mechanism compared to an analog touch interaction mechanism. FIG. 4 graphs the transmittance Tjk as a function of the depth z of the touch. The dimension z is into and out of the active touch surface. Curve 410 is a binary response. At low z (i.e., when the touch has not yet disturbed the beam), the transmittance Tjk is at its maximum. However, at some point z0, the touch breaks the beam and the transmittance Tjk falls fairly suddenly to its minimum value. Curve 420 shows an analog response where the transition from maximum Tjk to minimum Tjk occurs over a wider range of z. If curve 420 is well behaved, it is possible to estimate z from the measured value of Tjk.

C. Emitters, Detectors and Couplers

Each emitter transmits light to a number of detectors. Usually, each emitter outputs light to more than one detector simultaneously. Similarly, each detector may receive light from a number of different emitters. The optical beams may be visible, infrared (IR) and/or ultraviolet light. The term “light” is meant to include all of these wavelengths and terms such as “optical” are to be interpreted accordingly.

Examples of the optical sources for the emitters include light emitting diodes (LEDs) and semiconductor lasers. IR sources can also be used. Modulation of optical beams can be achieved by directly modulating the optical source or by using an external modulator, for example a liquid crystal modulator or a deflected mirror modulator. Examples of sensor elements for the detector include charge coupled devices, photodiodes, photoresistors, phototransistors, and nonlinear all-optical detectors. Typically, the detectors output an electrical signal that is a function of the intensity of the received optical beam.

The emitters and detectors may also include optics and/or electronics in addition to the main optical source and sensor element. For example, optics can be used to couple between the emitter/detector and the desired beam path. Optics can also reshape or otherwise condition the beam produced by the emitter or accepted by the detector. These optics may include lenses, Fresnel lenses, mirrors, filters, non-imaging optics and other optical components.

In this disclosure, the optical paths are shown unfolded for clarity. Thus, sources, optical beams and sensors are shown as lying in one plane. In actual implementations, the sources and sensors typically do not lie in the same plane as the optical beams. Various coupling approaches can be used. For example, a planar waveguide or optical fiber may be used to couple light to/from the actual beam path. Free space coupling (e.g., lenses and mirrors) may also be used. A combination may also be used, for example waveguided along one dimension and free space along the other dimension. Various coupler designs are described in U.S. Pat. No. 9,170,683, entitled “Optical Coupler,” which is incorporated by reference herein.

D. Optical Beam Paths

Another aspect of a touch-sensitive system is the shape and location of the optical beams and beam paths. In FIG. 1, the optical beams are shown as lines. These lines should be interpreted as representative of the beams, but the beams themselves are not necessarily narrow pencil beams. FIGS. 5A-5C illustrate different beam shapes when projected onto the active touch surface (beam footprint).

FIG. 5A shows a point emitter E, point detector D and a narrow “pencil” beam 510 from the emitter to the detector. In FIG. 5B, a point emitter E produces a fan-shaped beam 520 received by the wide detector D. In FIG. 5C, a wide emitter E produces a “rectangular” beam 530 received by the wide detector D. These are top views of the beams and the shapes shown are the footprints of the beam paths. Thus, beam 510 has a line-like footprint, beam 520 has a triangular footprint which is narrow at the emitter and wide at the detector, and beam 530 has a fairly constant width rectangular footprint. In FIG. 5, the detectors and emitters are represented by their widths, as seen by the beam path. The actual optical sources and sensors may not be so wide. Rather, optics (e.g., cylindrical lenses or mirrors) can be used to effectively widen or narrow the lateral extent of the actual sources and sensors.

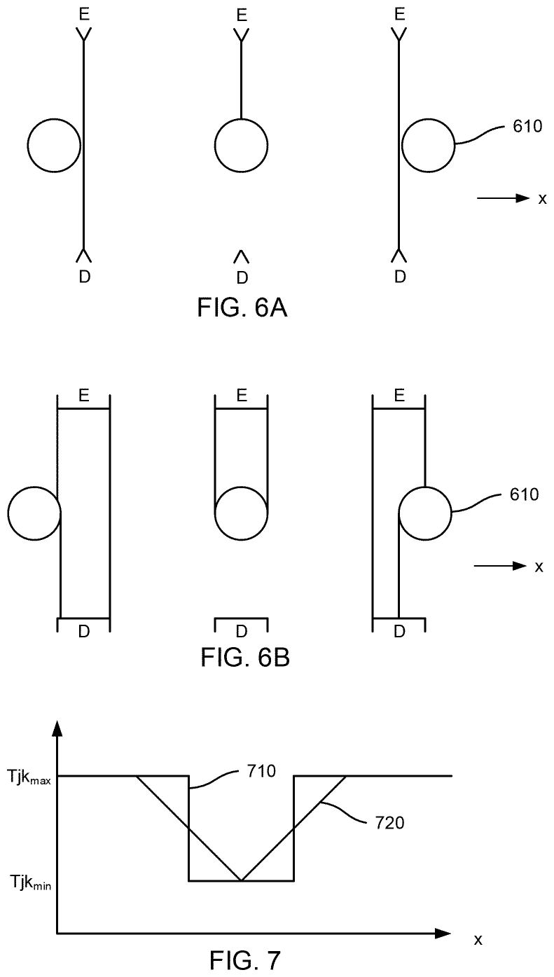

FIGS. 6A-6B and 7 show, for a constant z position and various x positions, how the width of the footprint can determine whether the transmission coefficient Tjk behaves as a binary or analog quantity. In these figures, a touch point has contact area 610. Assume that the touch is fully blocking, so that any light that hits contact area 610 will be blocked. FIG. 6A shows what happens as the touch point moves left to right past a narrow beam. In the leftmost situation, the beam is not blocked at all (i.e., maximum Tjk) until the right edge of the contact area 610 interrupts the beam. At this point, the beam is fully blocked (i.e., minimum Tjk), as is also the case in the middle scenario. It continues as fully blocked until the entire contact area moves through the beam. Then, the beam is again fully unblocked, as shown in the righthand scenario. Curve 710 in FIG. 7 shows the transmittance Tjk as a function of the lateral position x of the contact area 610. The sharp transitions between minimum and maximum Tjk show the binary nature of this response.

FIG. 6B shows what happens as the touch point moves left to right past a wide beam. In the leftmost scenario, the beam is just starting to be blocked. The transmittance Tjk starts to fall off but is at some value between the minimum and maximum values. The transmittance Tjk continues to fall as the touch point blocks more of the beam, until the middle situation where the beam is fully blocked. Then the transmittance Tjk starts to increase again as the contact area exits the beam, as shown in the righthand situation. Curve 720 in FIG. 7 shows the transmittance Tjk as a function of the lateral position x of the contact area 610. The transition over a broad range of x shows the analog nature of this response.

E. Active Area Coverage

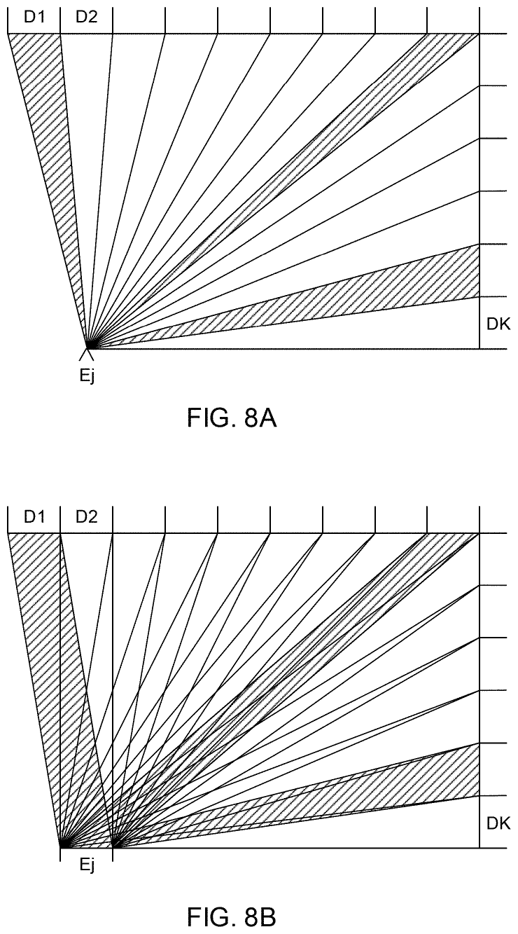

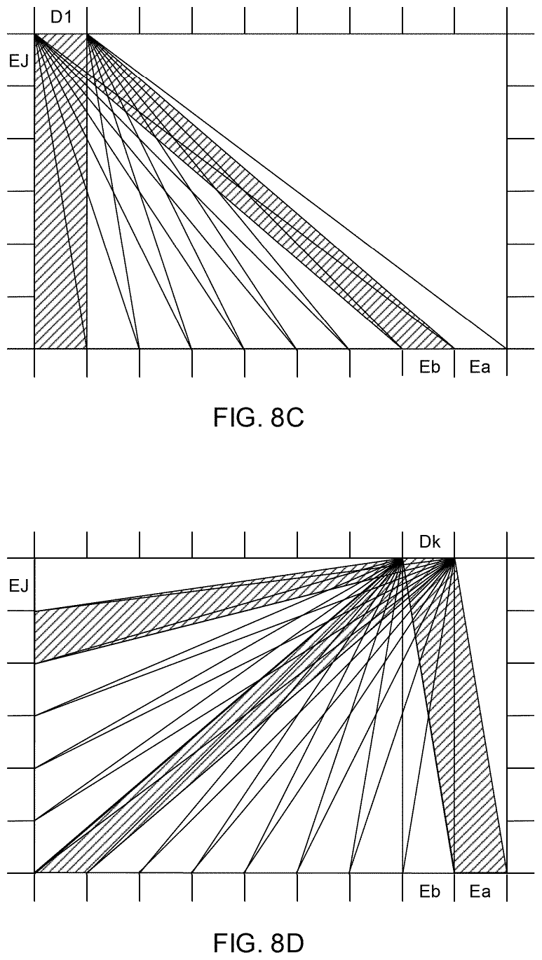

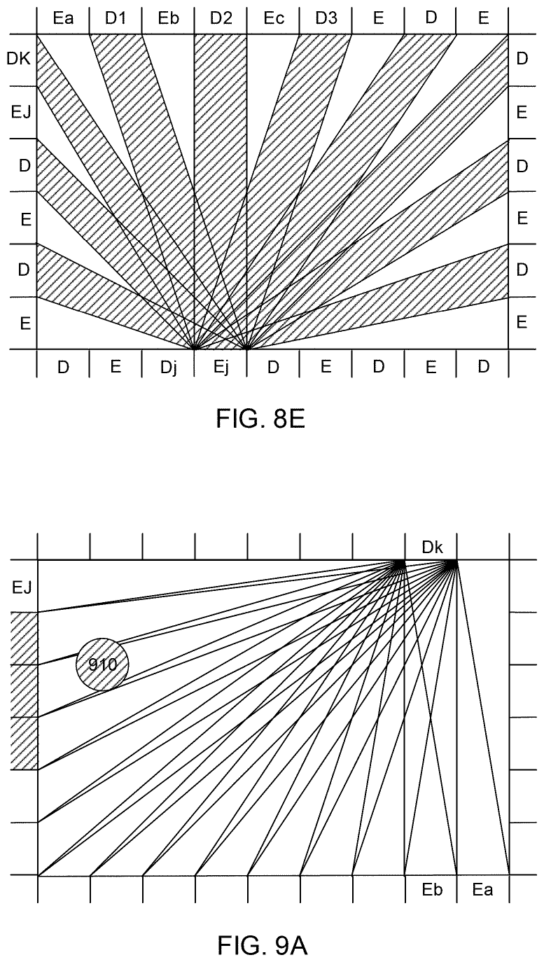

FIG. 8A is a top view illustrating the beam pattern produced by a point emitter. Emitter Ej transmits beams to wide detectors D1-DK. Three beams are shaded for clarity: beam j1, beam j(K−1) and an intermediate beam. Each beam has a fan-shaped footprint. The aggregate of all footprints is emitter Ej's coverage area. That is, any touch event that falls within emitter Ej's coverage area will disturb at least one of the beams from emitter Ej. FIG. 8B is a similar diagram, except that emitter Ej is a wide emitter and produces beams with “rectangular” footprints (actually, trapezoidal but they are referred to as rectangular for convenience). The three shaded beams are for the same detectors as in FIG. 8A.

Note that every emitter Ej may not produce beams for every detector Dk. In FIG. 1, consider beam path aK which would go from emitter Ea to detector DK. First, the light produced by emitter Ea may not travel in this direction (i.e., the radiant angle of the emitter may not be wide enough) so there may be no physical beam at all, or the acceptance angle of the detector may not be wide enough so that the detector does not detect the incident light. Second, even if there was a beam and it was detectable, it may be ignored because the beam path is not located in a position to produce useful information. Hence, the transmission coefficients Tjk may not have values for all combinations of emitters Ej and detectors Dk.

The footprints of individual beams from an emitter and the coverage area of all beams from an emitter can be described using different quantities. Spatial extent (i.e., width), angular extent (i.e., radiant angle for emitters, acceptance angle for detectors), and footprint shape are quantities that can be used to describe individual beam paths as well as an individual emitter's coverage area.

An individual beam path from one emitter Ej to one detector Dk can be described by the emitter Ej's width, the detector Dk's width and/or the angles and shape defining the beam path between the two.

These individual beam paths can be aggregated over all detectors for one emitter Ej to produce the coverage area for emitter Ej. Emitter Ej's coverage area can be described by the emitter Ej's width, the aggregate width of the relevant detectors Dk and/or the angles and shape defining the aggregate of the beam paths from emitter Ej. Note that the individual footprints may overlap (see FIG. 8B close to the emitter). Therefore, an emitter's coverage area may not be equal to the sum of its footprints. The ratio of (the sum of an emitter's footprints)/(emitter's cover area) is one measure of the amount of overlap.

The coverage areas for individual emitters can be aggregated over all emitters to obtain the overall coverage for the system. In this case, the shape of the overall coverage area is not so interesting because it should cover the entirety of the active touch area 131. However, not all points within the active touch area 131 will be covered equally. Some points may be traversed by many beam paths while other points traversed by far fewer. The distribution of beam paths over the active touch area 131 may be characterized by calculating how many beam paths traverse different (x,y) points within the active touch area. The orientation of beam paths is another aspect of the distribution. An (x,y) point that is derived from three beam paths that are all running roughly in the same direction usually will be a weaker distribution than a point that is traversed by three beam paths that all run at 60 degree angles to each other.

The discussion above for emitters also holds for detectors. The diagrams constructed for emitters in FIGS. 8A-8B can also be constructed for detectors. For example, FIG. 8C shows a similar diagram for detector D1 of FIG. 8B. That is, FIG. 8C shows all beam paths received by detector D1. Note that in this example, the beam paths to detector D1 are only from emitters along the bottom edge of the active touch area. The emitters on the left edge are not worth connecting to D1 and there are no emitters on the right edge (in this example design). FIG. 8D shows a diagram for detector Dk, which is an analogous position to emitter Ej in FIG. 8B.

A detector Dk's coverage area is then the aggregate of all footprints for beams received by a detector Dk. The aggregate of all detector coverage areas gives the overall system coverage.

The coverage of the active touch area 131 depends on the shapes of the beam paths, but also depends on the arrangement of emitters and detectors. In most applications, the active touch area is rectangular in shape, and the emitters and detectors are located along the four edges of the rectangle.

In a preferred approach, rather than having only emitters along certain edges and only detectors along the other edges, emitters and detectors are interleaved along the edges. FIG. 8E shows an example of this where emitters and detectors are alternated along all four edges. The shaded beams show the coverage area for emitter Ej.

F. Multiplexing

Since multiple emitters transmit multiple optical beams to multiple detectors, and since the behavior of individual beams is generally desired, a multiplexing/demultiplexing scheme is used. For example, each detector typically outputs a single electrical signal indicative of the intensity of the incident light, regardless of whether that light is from one optical beam produced by one emitter or from many optical beams produced by many emitters. However, the transmittance Tjk is a characteristic of an individual optical beam jk.

Different types of multiplexing can be used. Depending upon the multiplexing scheme used, the transmission characteristics of beams, including their content and when they are transmitted, may vary. Consequently, the choice of multiplexing scheme may affect both the physical construction of the optical touch-sensitive device as well as its operation.

One approach is based on code division multiplexing. In this approach, the optical beams produced by each emitter are encoded using different codes. A detector receives an optical signal which is the combination of optical beams from different emitters, but the received beam can be separated into its components based on the codes. This is described in further detail in U.S. Pat. No. 8,227,742, entitled “Optical Control System With Modulated Emitters,” which is incorporated by reference herein.

Another similar approach is frequency division multiplexing. In this approach, rather than modulated by different codes, the optical beams from different emitters are modulated by different frequencies. The frequencies are low enough that the different components in the detected optical beam can be recovered by electronic filtering or other electronic or software means.

Time division multiplexing can also be used. In this approach, different emitters transmit beams at different times. The optical beams and transmission coefficients Tjk are identified based on timing. If only time multiplexing is used, the controller cycles through the emitters quickly enough to meet a specified touch sampling rate.

Other multiplexing techniques commonly used with optical systems include wavelength division multiplexing, polarization multiplexing, spatial multiplexing and angle multiplexing. Electronic modulation schemes, such as PSK, QAM and OFDM, may also be possibly applied to distinguish different beams.

Several multiplexing techniques may be used together. For example, time division multiplexing and code division multiplexing could be combined. Rather than code division multiplexing 128 emitters or time division multiplexing 128 emitters, the emitters might be broken down into 8 groups of 16. The 8 groups are time division multiplexed so that only 16 emitters are operating at any one time, and those 16 emitters are code division multiplexed. This might be advantageous, for example, to minimize the number of emitters active at any given point in time to reduce the power requirements of the device.

### III. Processing Phase

In the processing phase 220 of FIG. 2, the transmission coefficients Tjk are used to determine the locations of touch points. Different approaches and techniques can be used, including candidate touch points, line imaging, location interpolation, touch event templates, multi-pass processing and beam weighting.

A. Candidate Touch Points

One approach to determine the location of touch points is based on identifying beams that have been affected by a touch event (based on the transmission coefficients Tjk) and then identifying intersections of these interrupted beams as candidate touch points. The list of candidate touch points can be refined by considering other beams that are in proximity to the candidate touch points or by considering other candidate touch points. This approach is described in further detail in U.S. Pat. No. 8,350,831, “Method and Apparatus for Detecting a Multitouch Event in an Optical Touch-Sensitive Device,” which is incorporated herein by reference.

B. Line Imaging

This technique is based on the concept that the set of beams received by a detector form a line image of the touch points, where the viewpoint is the detector's location. The detector functions as a one-dimensional camera that is looking at the collection of emitters. Due to reciprocity, the same is also true for emitters. The set of beams transmitted by an emitter form a line image of the touch points, where the viewpoint is the emitter's location.

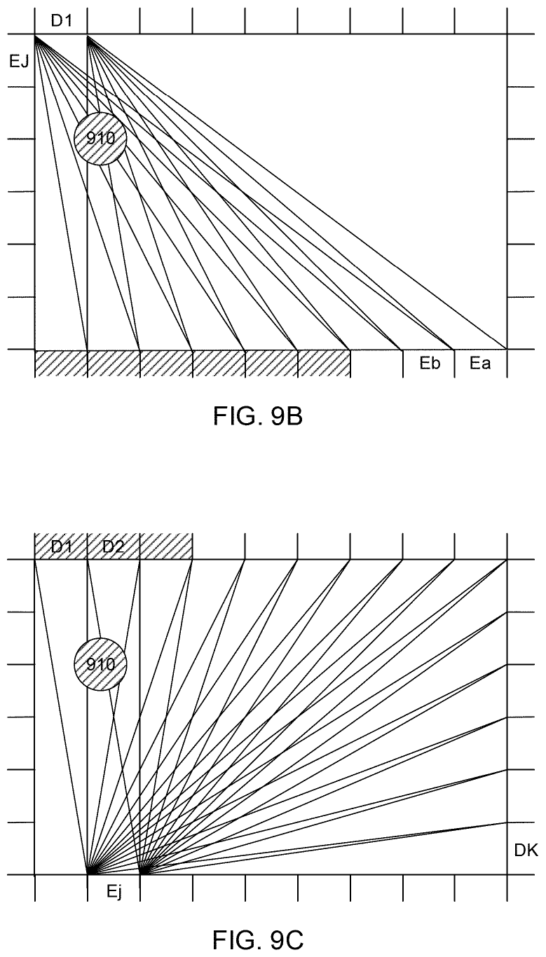

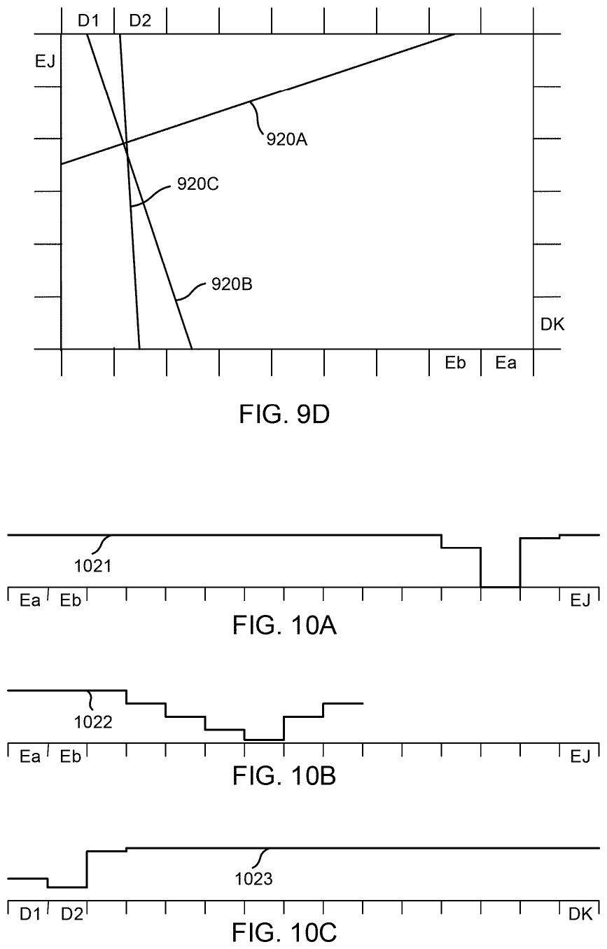

FIGS. 9-10 illustrate this concept using the emitter/detector layout shown in FIGS. 8B-8D. For convenience, the term “beam terminal” will be used to refer to emitters and detectors. Thus, the set of beams from a beam terminal (which could be either an emitter or a detector) form a line image of the touch points, where the viewpoint is the beam terminal's location.

FIGS. 9A-C shows the physical set-up of active area, emitters and detectors. In this example, there is a touch point with contact area 910. FIG. 9A shows the beam pattern for beam terminal Dk, which are all the beams from emitters Ej to detector Dk. A shaded emitter indicates that beam is interrupted, at least partially, by the touch point 910. FIG. 10A shows the corresponding line image 1021 “seen” by beam terminal Dk. The beams to terminals Ea, Eb, . . . E(J−4) are uninterrupted so the transmission coefficient is at full value. The touch point appears as an interruption to the beams with beam terminals E(J−3), E(J−2) and E(J−1), with the main blockage for terminal E(J−2). That is, the portion of the line image spanning beam terminals E(J−3) to E(J−1) is a one-dimensional image of the touch event.

FIG. 9B shows the beam pattern for beam terminal D1 and FIG. 10B shows the corresponding line image 1022 seen by beam terminal D1. Note that the line image does not span all emitters because the emitters on the left edge of the active area do not form beam paths with detector D1. FIGS. 9C and 10C show the beam patterns and corresponding line image 1023 seen by beam terminal Ej.

The example in FIGS. 9-10 use wide beam paths. However, the line image technique may also be used with narrow or fan-shaped beam paths.

FIGS. 10A-C show different images of touch point 910. The location of the touch event can be determined by processing the line images. For example, approaches based on correlation or computerized tomography algorithms can be used to determine the location of the touch event 910. However, simpler approaches are preferred because they require less compute resources.

The touch point 910 casts a “shadow” in each of the lines images 1021-1023. One approach is based on finding the edges of the shadow in the line image and using the pixel values within the shadow to estimate the center of the shadow. A line can then be drawn from a location representing the beam terminal to the center of the shadow. The touch point is assumed to lie along this line somewhere. That is, the line is a candidate line for positions of the touch point. FIG. 9D shows this. In FIG. 9D, line 920A is the candidate line corresponding to FIGS. 9A and 10A. That is, it is the line from the center of detector Dk to the center of the shadow in line image 1021. Similarly, line 920B is the candidate line corresponding to FIGS. 9B and 10B, and line 920C is the line corresponding to FIGS. 9C and 10C. The resulting candidate lines 920A-C have one end fixed at the location of the beam terminal, with the angle of the candidate line interpolated from the shadow in the line image. The center of the touch event can be estimated by combining the intersections of these candidate lines.

Each line image shown in FIG. 10 was produced using the beam pattern from a single beam terminal to all of the corresponding complimentary beam terminals (i.e., beam pattern from one detector to all corresponding emitters, or from one emitter to all corresponding detectors). As another variation, the line images could be produced by combining information from beam patterns of more than one beam terminal. FIG. 8E shows the beam pattern for emitter Ej. However, the corresponding line image will have gaps because the corresponding detectors do not provide continuous coverage. They are interleaved with emitters. However, the beam pattern for the adjacent detector Dj produces a line image that roughly fills in these gaps. Thus, the two partial line images from emitter Ej and detector Dj can be combined to produce a complete line image.

C. Location Interpolation

Applications typically will require a certain level of accuracy in locating touch points. One approach to increase accuracy is to increase the density of emitters, detectors and beam paths so that a small change in the location of the touch point will interrupt different beams.

Another approach is to interpolate between beams. In the line images of FIGS. 10A-C, the touch point interrupts several beams but the interruption has an analog response due to the beam width. Therefore, although the beam terminals may have a spacing of 4, the location of the touch point can be determined with greater accuracy by interpolating based on the analog values. This is also shown in curve 720 of FIG. 7. The measured Tjk can be used to interpolate the x position.

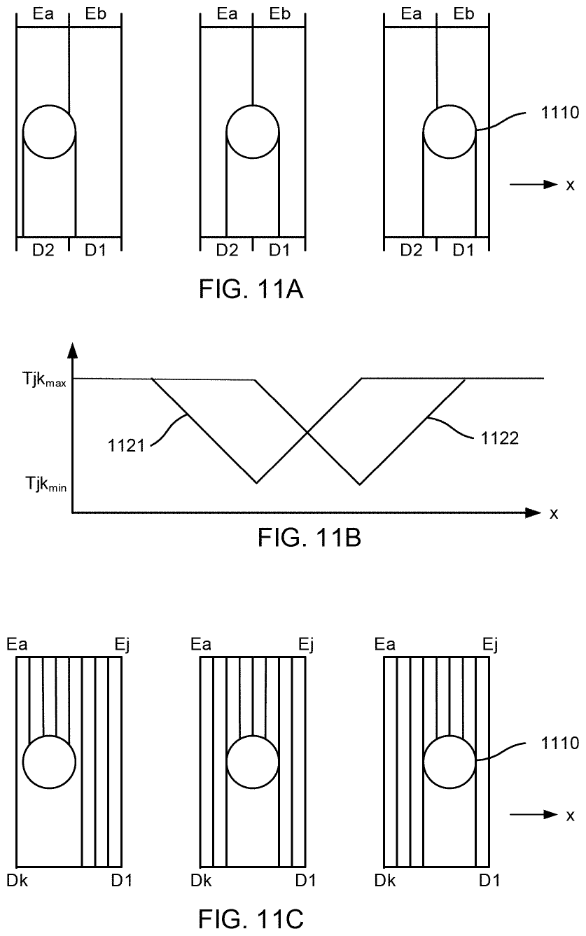

FIGS. 11A-B show one approach based on interpolation between adjacent beam paths. FIG. 11A shows two beam paths a2 and b1. Both of these beam paths are wide and they are adjacent to each other. In all three cases shown in FIG. 11A, the touch point 1110 interrupts both beams. However, in the lefthand scenario, the touch point is mostly interrupting beam a2. In the middle case, both beams are interrupted equally. In the righthand case, the touch point is mostly interrupting beam b1.

FIG. 11B graphs these two transmission coefficients as a function of x. Curve 1121 is for coefficient Ta2 and curve 1122 is for coefficient Tb1. By considering the two transmission coefficients Ta2 and Tb1, the x location of the touch point can be interpolated. For example, the interpolation can be based on the difference or ratio of the two coefficients.

The interpolation accuracy can be enhanced by accounting for any uneven distribution of light across the beams a2 and b1. For example, if the beam cross section is Gaussian, this can be taken into account when making the interpolation. In another variation, if the wide emitters and detectors are themselves composed of several emitting or detecting units, these can be decomposed into the individual elements to determine more accurately the touch location. This may be done as a secondary pass, having first determined that there is touch activity in a given location with a first pass. A wide emitter can be approximated by driving several adjacent emitters simultaneously. A wide detector can be approximated by combining the outputs of several detectors to form a single signal.

FIG. 11C shows a situation where a large number of narrow beams is used rather than interpolating a fewer number of wide beams. In this example, each beam is a pencil beam represented by a line in FIG. 11C. As the touch point 1110 moves left to right, it interrupts different beams. Much of the resolution in determining the location of the touch point 1110 is achieved by the fine spacing of the beam terminals. The edge beams may be interpolated to provide an even finer location estimate.

D. Touch Event Templates

If the locations and shapes of the beam paths are known, which is typically the case for systems with fixed emitters, detectors, and optics, it is possible to predict in advance the transmission coefficients for a given touch event. Templates can be generated a priori for expected touch events. The determination of touch events then becomes a template matching problem.

If a brute force approach is used, then one template can be generated for each possible touch event. However, this can result in a large number of templates. For example, assume that one class of touch events is modeled as oval contact areas and assume that the beams are pencil beams that are either fully blocked or fully unblocked. This class of touch events can be parameterized as a function of five dimensions: length of major axis, length of minor axis, orientation of major axis, x location within the active area and y location within the active area. A brute force exhaustive set of templates covering this class of touch events must span these five dimensions. In addition, the template itself may have a large number of elements. Thus, it is desirable to simplify the set of templates.

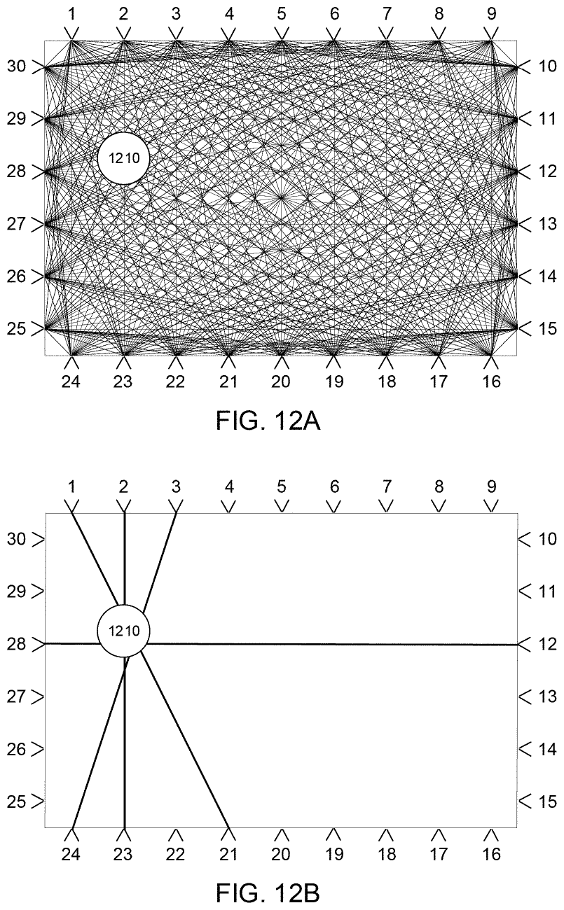

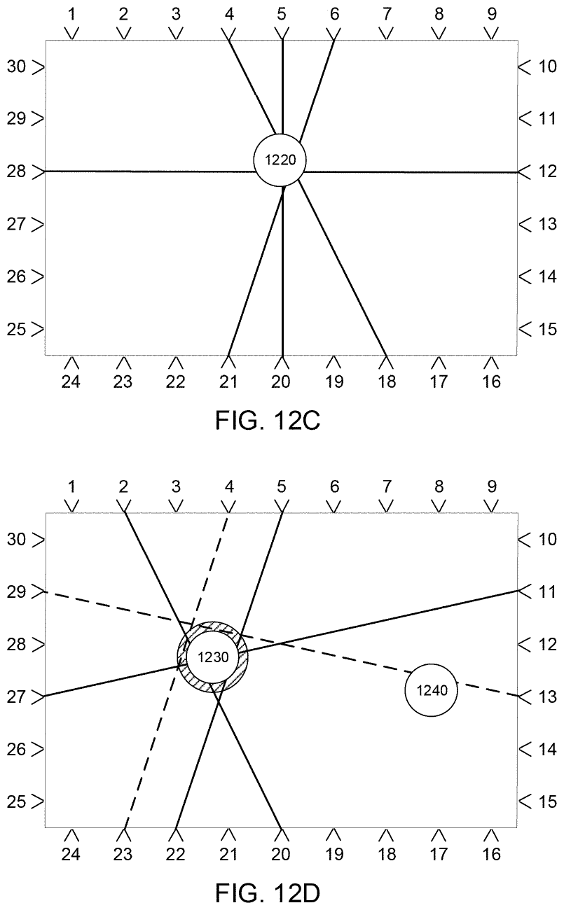

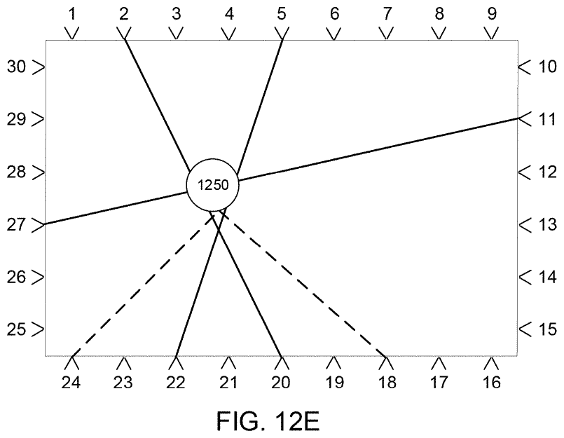

FIG. 12A shows all of the possible pencil beam paths between any two of 30 beam terminals. In this example, beam terminals are not labeled as emitter or detector. Assume that there are sufficient emitters and detectors to realize any of the possible beam paths. One possible template for contact area 1210 is the set of all beam paths that would be affected by the touch. However, this is a large number of beam paths, so template matching will be more difficult. In addition, this template is very specific to contact area 1210. If the contact area changes slightly in size, shape or position, the template for contact area 1210 will no longer match exactly. Also, if additional touches are present elsewhere in the active area, the template will not match the detected data well. Thus, although using all possible beam paths can produce a fairly discriminating template, it can also be computationally intensive to implement.

FIG. 12B shows a simpler template based on only four beams that would be interrupted by contact area 1210. This is a less specific template since other contact areas of slightly different shape, size or location will still match this template. This is good in the sense that fewer templates will be required to cover the space of possible contact areas. This template is less precise than the full template based on all interrupted beams. However, it is also faster to match due to the smaller size. These types of templates often are sparse relative to the full set of possible transmission coefficients.

Note that a series of templates could be defined for contact area 1210, increasing in the number of beams contained in the template: a 2-beam template, a 4-beam template, etc. In one embodiment, the beams that are interrupted by contact area 1210 are ordered sequentially from 1 to N. An n-beam template can then be constructed by selecting the first n beams in the order. Generally speaking, beams that are spatially or angularly diverse tend to yield better templates. That is, a template with three beam paths running at 60 degrees to each other and not intersecting at a common point tends to produce a more robust template than one based on three largely parallel beams which are in close proximity to each other. In addition, more beams tends to increase the effective signal-to-noise ratio of the template matching, particularly if the beams are from different emitters and detectors.

The template in FIG. 12B can also be used to generate a family of similar templates. In FIG. 12C, the contact area 1220 is the same as in FIG. 12B, but shifted to the right. The corresponding four-beam template can be generated by shifting beams (1,21) (2,23) and (3,24) in FIG. 12B to the right to beams (4,18) (5,20) and (6,21), as shown in FIG. 12C. These types of templates can be abstracted. The abstraction will be referred to as a template model. This particular model is defined by the beams (12,28) (i, 22−i) (i+1,24−i) (i+2,25−i) for i=1 to 6. In one approach, the model is used to generate the individual templates and the actual data is matched against each of the individual templates. In another approach, the data is matched against the template model. The matching process then includes determining whether there is a match against the template model and, if so, which value of i produces the match.

FIG. 12D shows a template that uses a “touch-free” zone around the contact area. The actual contact area is 1230. However, it is assumed that if contact is made in area 1230, then there will be no contact in the immediately surrounding shaded area. Thus, the template includes both (a) beams in the contact area 1230 that are interrupted, and (b) beams in the shaded area that are not interrupted. In FIG. 12D, the solid lines (2,20) (5,22) and (11,27) are interrupted beams in the template and the dashed lines (4,23) and (13,29) are uninterrupted beams in the template. Note that the uninterrupted beams in the template may be interrupted somewhere else by another touch point, so their use should take this into consideration. For example, dashed beam (13,29) could be interrupted by touch point 1240.

FIG. 12E shows an example template that is based both on reduced and enhanced transmission coefficients. The solid lines (2,20) (5,22) and (11,27) are interrupted beams in the template, meaning that their transmission coefficients should decrease. However, the dashed line (18,24) is a beam for which the transmission coefficient should increase due to reflection or scattering from the touch point 1250.

Other templates will be apparent and templates can be processed in a number of ways. In a straightforward approach, the disturbances for the beams in a template are simply summed or averaged. This can increase the overall SNR for such a measurement, because each beam adds additional signal while the noise from each beam is presumably independent. In another approach, the sum or other combination could be a weighted process, where not all beams in the template are given equal weight. For example, the beams which pass close to the center of the touch event being modeled could be weighted more heavily than those that are further away. Alternately, the angular diversity of beams in the template could also be expressed by weighting. Angular diverse beams are more heavily weighted than beams that are not as diverse.

In a case where there is a series of N beams, the analysis can begin with a relatively small number of beams. Additional beams can be added to the processing as needed until a certain confidence level (or SNR) is reached. The selection of which beams should be added next could proceed according to a predetermined schedule. Alternately, it could proceed depending on the processing results up to that time. For example, if beams with a certain orientation are giving low confidence results, more beams along that orientation may be added (at the expense of beams along other orientations) in order to increase the overall confidence.

The data records for templates can also include additional details about the template. This information may include, for example, location of the contact area, size and shape of the contact area and the type of touch event being modeled (e.g., fingertip, stylus, etc.).

In addition to intelligent design and selection of templates, symmetries can also be used to reduce the number of templates and/or computational load. Many applications use a rectangular active area with emitters and detectors placed symmetrically with respect to x and y axes. In that case, quadrant symmetry can be used to achieve a factor of four reduction. Templates created for one quadrant can be extended to the other three quadrants by taking advantage of the symmetry. Alternately, data for possible touch points in the other three quadrants can be transformed and then matched against templates from a single quadrant. If the active area is square, then there may be eight-fold symmetry.

Other types of redundancies, such as shift-invariance, can also reduce the number of templates and/or computational load. The template model of FIGS. 12B-C is one example.

In addition, the order of processing templates can also be used to reduce the computational load. There can be substantial similarities between the templates for touches which are nearby. They may have many beams in common, for example. This can be taken advantage of by advancing through the templates in an order that allows one to take advantage of the processing of the previous templates.

E. Multi-Pass Processing

Referring to FIG. 2, the processing phase need not be a single-pass process nor is it limited to a single technique. Multiple processing techniques may be combined or otherwise used together to determine the locations of touch events.

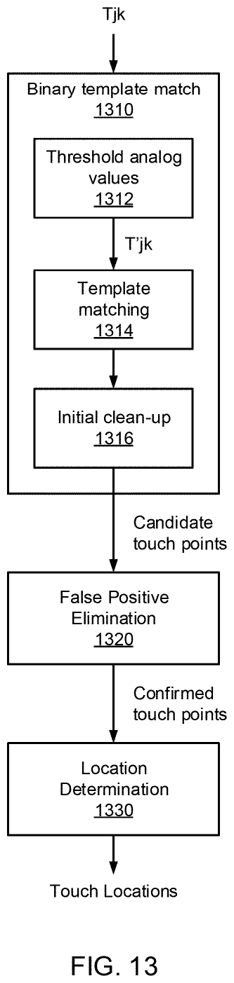

FIG. 13 is a flow diagram of a multi-pass processing phase based on several stages. This example uses the physical set-up shown in FIG. 9, where wide beams are transmitted from emitters to detectors. The transmission coefficients Tjk are analog values, ranging from 0 (fully blocked) to 1 (fully unblocked).

The first stage 1310 is a coarse pass that relies on a fast binary template matching, as described with respect to FIGS. 12B-D. In this stage, the templates are binary and the transmittances T′jk are also assumed to be binary. The binary transmittances T′jk can be generated from the analog values Tjk by rounding or thresholding 1312 the analog values. The binary values T′jk are matched 1314 against binary templates to produce a preliminary list of candidate touch points. Thresholding transmittance values may be problematic if some types of touches do not generate any beams over the threshold value. An alternative is to threshold the combination (by summation for example) of individual transmittance values.

Some simple clean-up 1316 is performed to refine this list. For example, it may be simple to eliminate redundant candidate touch points or to combine candidate touch points that are close or similar to each other. For example, the binary transmittances T′jk might match the template for a 5 mm diameter touch at location (x,y), a 7 mm diameter touch at (x,y) and a 9 mm diameter touch at (x,y). These may be consolidated into a single candidate touch point at location (x,y).

Stage 1320 is used to eliminate false positives, using a more refined approach. For each candidate touch point, neighboring beams may be used to validate or eliminate the candidate as an actual touch point. The techniques described in U.S. Pat. No. 8,350,831 may be used for this purpose. This stage may also use the analog values Tjk, in addition to accounting for the actual width of the optical beams. The output of stage 1320 is a list of confirmed touch points.

The final stage 1330 refines the location of each touch point. For example, the interpolation techniques described previously can be used to determine the locations with better accuracy. Since the approximate location is already known, stage 1330 may work with a much smaller number of beams (i.e., those in the local vicinity) but might apply more intensive computations to that data. The end result is a determination of the touch locations.

Other techniques may also be used for multi-pass processing. For example, line images or touch event models may also be used. Alternatively, the same technique may be used more than once or in an iterative fashion. For example, low resolution templates may be used first to determine a set of candidate touch locations, and then higher resolution templates or touch event models may be used to more precisely determine the precise location and shape of the touch.

F. Beam Weighting

In processing the transmission coefficients, it is common to weight or to prioritize the transmission coefficients. Weighting effectively means that some beams are more important than others. Weightings may be determined during processing as needed, or they may be predetermined and retrieved from lookup tables or lists.

One factor for weighting beams is angular diversity. Usually, angularly diverse beams are given a higher weight than beams with comparatively less angular diversity. Given one beam, a second beam with small angular diversity (i.e., roughly parallel to the first beam) may be weighted lower because it provides relatively little additional information about the location of the touch event beyond what the first beam provides. Conversely, a second beam which has a high angular diversity relative to the first beam may be given a higher weight in determining where along the first beam the touch point occurs.

Another factor for weighting beams is position difference between the emitters and/or detectors of the beams (i.e., spatial diversity). Usually, greater spatial diversity is given a higher weight since it represents “more” information compared to what is already available.

Another possible factor for weighting beams is the density of beams. If there are many beams traversing a region of the active area, then each beam is just one of many and any individual beam is less important and may be weighted less. Conversely, if there are few beams traversing a region of the active area, then each of those beams is more significant in the information that it carries and may be weighted more.

In another aspect, the nominal beam transmittance (i.e., the transmittance in the absence of a touch event) could be used to weight beams. Beams with higher nominal transmittance can be considered to be more “trustworthy” than those which have lower nominal transmittance since those are more vulnerable to noise. A signal-to-noise ratio, if available, can be used in a similar fashion to weight beams. Beams with higher signal-to-noise ratio may be considered to be more “trustworthy” and given higher weight.

The weightings, however determined, can be used in the calculation of a figure of merit (confidence) of a given template associated with a possible touch location. Beam transmittance/signal-to-noise ratio can also be used in the interpolation process, being gathered into a single measurement of confidence associated with the interpolated line derived from a given touch shadow in a line image. Those interpolated lines which are derived from a shadow composed of “trustworthy” beams can be given greater weight in the determination of the final touch point location than those which are derived from dubious beam data.

These weightings can be used in a number of different ways. In one approach, whether a candidate touch point is an actual touch event is determined based on combining the transmission coefficients for the beams (or a subset of the beams) that would be disturbed by the candidate touch point. The transmission coefficients can be combined in different ways: summing, averaging, taking median/percentile values or taking the root mean square, for example. The weightings can be included as part of this process: taking a weighted average rather than an unweighted average, for example. Combining multiple beams that overlap with a common contact area can result in a higher signal to noise ratio and/or a greater confidence decision. The combining can also be performed incrementally or iteratively, increasing the number of beams combined as necessary to achieve higher SNR, higher confidence decision and/or to otherwise reduce ambiguities in the determination of touch events.

### IV. Passive Instrument with Identification

Introduction

Various approaches may be used to identify instruments, such as distinguishing styli (also referred to as pens) from fingers and other instruments when used with optical touch sensors. One method includes the instrument having a tip/protrusion which has different optical transmission behavior when observed at different azimuth angles around the tip. The tip may be passive (i.e., the tip does not include electronic components for detecting the location of the tip or for communicating other status information about the instrument to the touch-sensitive device). The optical touch sensors can be associated with an electronic display to form a touchscreen, but may also be used without any associated display device, or one which is not interactive, such as printed indicia.

The instrument exemplified here is a pen, where the coded body is the area approaching the tip of the pen, though it is to be understood in a general sense which is applicable to other instrument types and coded body configurations.

The terms light and optical are not specific to visible wavelengths and include any wavelength from 100 nm to 20 μm.

### DISCLOSURE

Touch sensors making use of sensing light which travels above a touch surface can be operated by many types of objects, including fingers, pens, and erasers. Specific instruments can be devised for use with such a sensor and are detected by the changes they impose upon the optical transmission loss between optical emitters and optical detectors arranged around the periphery of the touch sensitive surface.

The beams between emitters and detectors may be present at many angles on the surface, with the emitters configured to radiate over a wide range of azimuth angles travelling through the air and arriving at detectors similarly configured to be sensitive to the emitted light over a wide range of incident azimuth angles.

An instrument presented to the touch surface can have at least one prominent tip. It may be advantageous to determine the type of instrument in use and attributes of that instrument. This can be encoded into the optical interaction between the instrument and the beams.

For example, the shape of the tip can be selected to have differing transmission behavior with azimuth angle, where different tip designs convey an instrument type or attribute to the sensor. For example, the degree of circularity (a varying cross-section) will result in different losses to beams at different angles. By measuring the loss to beams at a range of azimuth angles, the circularity of the tip can be determined. A circular tip has a constant cross-section at all azimuth angles, so it gives rise to consistent beam loss values when the width and intensity profile of each beam is taken into account (where two beams are of differing effective optical width encounter a circular tip and both beams are wider than the cross-section of the tip, the relative loss of the wider of the two beams is smaller).

In contrast, non-circular tips interact with beams of different angles differently. One example of a non-circular tip is a solid elliptical prism, which gives rise to inconsistent beam loss values with angle because of the changing cross-section defined by an elliptical profile.

Analysis of the attenuation of beams encountering the tip over a range of azimuth angles reveals the degree to which the tip profile departs from a circular one and this can be used to differentiate tips with various levels of circularity. Objects such as fingers tend to show high degrees of circularity and so can readily be differentiated from instruments which may be of similar size, but less circular. Additional analysis, such as determining the angle at which minimum beam loss occurs can give an estimate of the orientation (rotation around the tip axis) of the instrument. This can be applied to give the user an additional level of control to supplement the location of the instrument on the touch surface and the type of instrument in use.

Drawing and other interactive systems which make use of optical sensing paths which are above (and substantially parallel to) the touch surface can benefit from the use of this angular encoding, but instrument differentiation can be impaired if the instrument is presented at an angle other than a normal to the touch surface. Tilting the instrument generally modifies the optical behavior observed in the sensing plane (close to the touch surface). However, users generally prefer being free to hold the instrument at an angle of their choosing.

Also, the optical sensing plane may be at various elevations above the touch surface depending on the flatness of that surface. Construction constraints imposed on the manufacture of these devices require that the touch surface does not intrude into the sensing plane, so the surfaces often have some degree of concavity. The result is that the distance from the sensing plane to the touch surface is positive and may vary (e.g., from 0 mm to 10 mm) across the surface of a typical sensor associated with a display of 75″ diagonal dimension. For smaller touch surfaces, smaller ranges may be typical (e.g., 0 mm to 5 mm). Various techniques may be used to differentiate between instruments that accommodate the various sensing plane elevations expected in a given system.

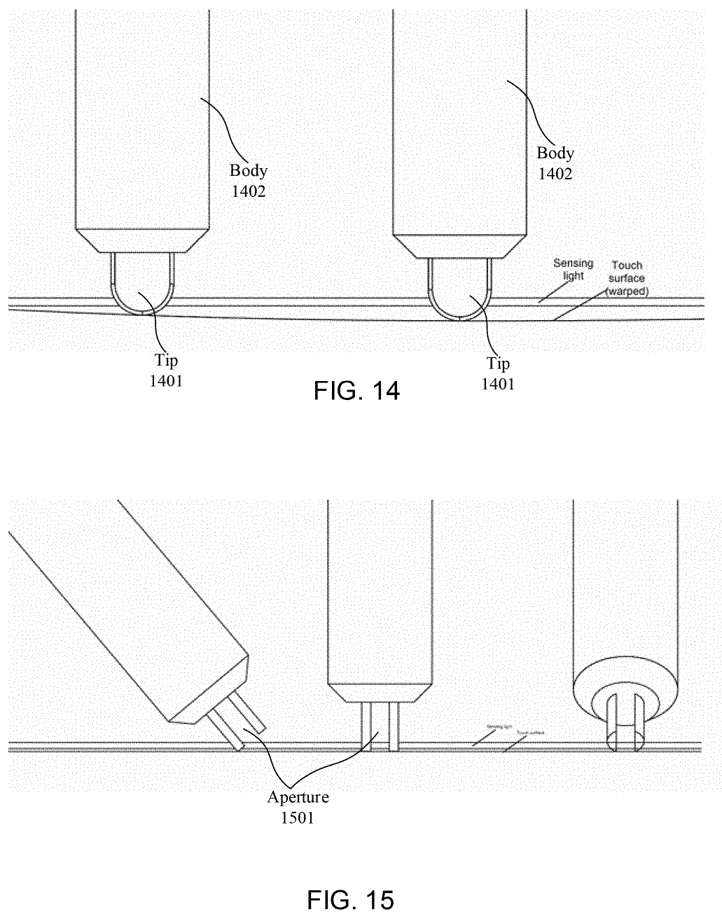

FIG. 14 shows how warping results in a range of height intervals between the touch surface and the sensing plane for an OTS configuration.

Where there is a large distance between the touch surface and the plane of the sensing light used to detect touches, problematic premature detection of a touch (pre-touch) can occur. To avoid this, touch sensors may be designed to have as little warp as possible and to have the sensing plane as close to the touch surface as possible.

This is generally beneficial but causes a problem for the design of instruments which have some optical attribute to be detected by the sensing light, such as an instrument identity encoded in the optical attenuation properties of the tip 1401 against sensing beam azimuth angle. In particular, tilting the instrument body 1402 can present a very different part of the tip 1401 to the sensing system and thus it is not a straightforward matter to retain some detectable optical attribute.

FIG. 15 shows a pen instrument with a solid cylindrical tip and an aperture 1501 to encode an angular transmission behavior (i.e. there is a path through the tip which will offer reduced attenuation to light in that direction).

FIG. 15 also illustrates a problem with this design; the sensing light passes through the aperture 1501 when the pen is upright, but this is compromised when the tip is tilted in certain directions, as seen on the left side of the figure. This is because tilting of the tip raises features of the tip above the plane of the sensing light, which in this example is near to the touch surface to reduce pre-touch effects.

One instrument design that facilitates differentiation when inclined and is also accommodating of various height intervals between the touch surface and the optical sensing plane is a “blade.” A blade in this context is a shape which is narrower in one axis than the other when considered in plan projection relative to the sensing surface. For example, the shape could be a solid elliptical cylinder, or a solid rectangular prism.

If the light is to pass through transmissive material in the instrument tip, it is generally advantageous for the path it follows to have surfaces which are parallel so that no significant redirection of the sensing light occurs. Refraction within the tip material may cause a small positional offset, but this is not normally problematic. One example of tip shape with these properties is a solid rectangular prism. The prism may have a rounded or faceted end to facilitate tilting of the pen in the plane of the blade which still retaining orientation-distinguishing properties.

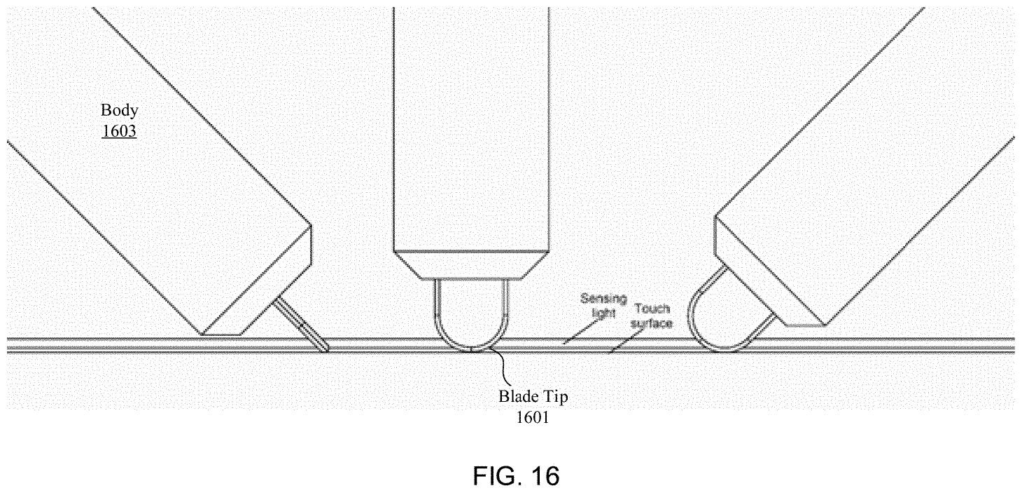

FIG. 16 shows an instrument with a body 1603 and blade protrusion tip 1601. This shows that the directional behavior (the profile is wider in one axis than the other, so it will attenuate more in one axis than the other) is present at various angles of tilt in different directions.

A thin dimension in at least one axis is beneficial when the blade 1601 is rotated (tilted) around that axis. When tilted, the end of the blade rises off the touch surface by a small amount such that sensing light can still pass through the blade and be used to identify that this is a particular instrument blade 1601, telling one from another, and from other object types. It can also encode the mode of an instrument, such as which particular tip is in use (for example, a pen instrument with tips at both ends).

This tip design is advantageous not just when used with angular coding methods, but with other transmissive encoding and retro-reflective methods too. For example, a system of instrument identity coding which is based on a wavelength-selective filter material or structure used in the blade can have optical sensing beams operating at various optical wavelengths which are attenuated variously, depending on the interaction between the beam wavelengths and the wavelength-selective attenuation of a given tip. A blade design may enable the optical path through the tip including the wavelength-selective material or structure over a range of tilt angles.

Attenuating Blade

Blades 1601 can use simple attenuation encoding. A pen blade 1601 can be manufacturing with an attenuating, diffusing, reflecting, or refracting material or structure which reduces transmission of light through it. This behavior can be detected as a loss on optical paths along which the blade 1601 is present, the degree of loss being indicative of the particular blade identity/type. The attenuation measured can be combined with the estimated span of the blade to give a loss-per-unit-area as an attribute to differentiate one blade from another.

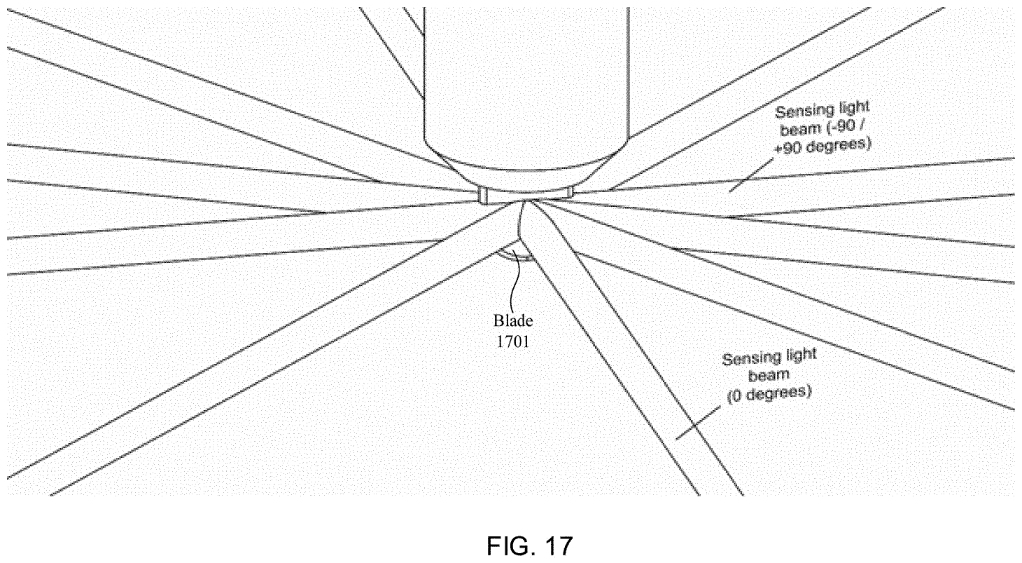

The beams in the touch sensor may cover a wide range of angles. FIG. 17 is a simplified illustration of sensing beams encountering a pen blade tip 1701.

Mapping the transmission coefficients (beam loss values) for beams at various angles of incidence with the tip 1701 gives a polar response plot indicating the attenuation attributable to the tip 1701 for each available beam angle.

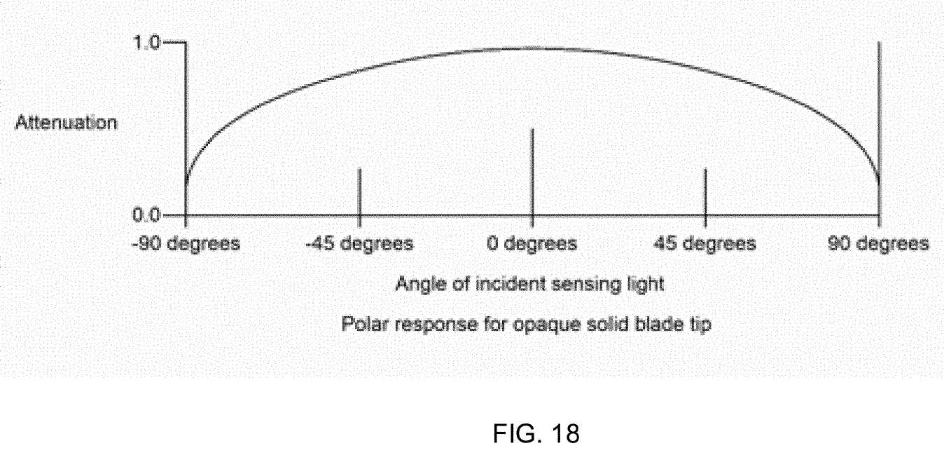

FIG. 18 shows a polar response for an example solid opaque blade tip 1701. In this case, attenuation is at a minimum at the −90/+90 degree angles which represent light encountering the narrow end-on profile of the blade 1701. At angles closer to zero degrees (perpendicular to the plane of the blade), the attenuation rises as the projected width of the blade 1701 increases and attenuates beams more completely. This effect may saturate at a maximum value when the blade is wider than the sensing beams.

Analysis of the polar response of a blade tip 1701 allows the orientation of the blade to be determined. This may be the angle at which the lowest attenuation is seen (because the blade 1701 presents a minimal cross-section area when side-on). Estimating the attenuation in the blade 1701 can be done, for example, at an angle close to 90 degrees to the orientation (side-on) blade angle. Various materials, patterns, and structures give a wide variety of optical attenuation values. For example, a pattern of dots printed in opaque ink on a transmissive substrate can give a well-controlled attenuation and one which can be increased or reduced in a deterministic way. Increasing the size of the dots or reducing the clear space between them so that the proportion of opaque surface to transmissive surface is increased results in increased attenuation.

Diffusing Blade

Another encoding method to which the blade protrusion design can be advantageously applied is diffusion. A pen blade 1701 can be manufacturing with a diffusing material or structure which redirects incident light over a range of angles. This behavior can be detected as a simultaneous loss on optical paths along which the blade 1701 is present and a rise on optical paths which bypass the blade (because those paths receive their original amount of light energy supplemented by the light diffused by the pen blade).

Retro-Reflective Blade

Retro-reflective instrument tips can also make advantageous use of blade protrusions. This is true for both full retro-reflectors such as corner-cube designs, but also for in-plane retro-reflectors that reflect light in the same plane as it was incident, but not towards the source.

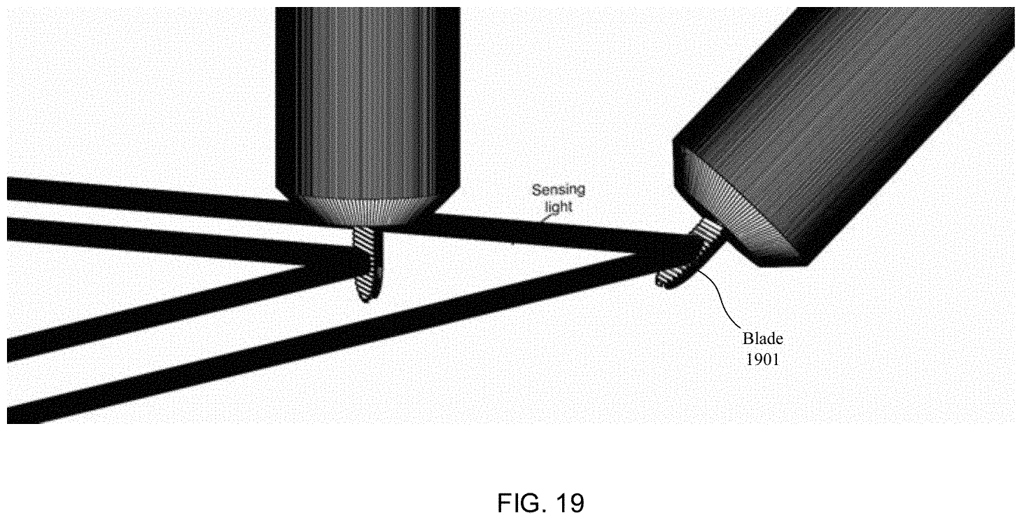

FIG. 19 shows a blade 1901 with an in-plane reflector which reflects light but preserves the plane of reflection so that light from emitters arrive at detectors in a different part of the periphery of the touch sensing area.

Orientation

An analysis of the optical beams passing through the locality of the blade may reveal the rotation of the blade around an axis at a normal to the touch surface. This can be used as part of the blade identification process, but also represents useful information on its own. Knowledge of the blade rotation can for example be used to simulate an ink writing device which is also sensitive to orientation, such as a calligraphy pen. In another application, blade rotation can be used to adjust on-screen controls which can be made to respond to rotation of the blade. A rotary audio volume control, for example, could be made to turn in response to the orientation of an instrument nearby, causing a corresponding audible level change. A digital drawing system can use the orientation of the pen to select attributes of the drawn strokes based on the rotation of the blade, the width of the line drawn, for example, or the color or transparency. Rotation of a blade in contact with the touch surface near a displayed object could also be used to apply graphical transformations to the object such as scaling, rotation, transparency, color, or selection from a set of options as in a menu. These graphical transformations may be an end in themselves (allowing the user to manipulate on-screen objects), or may take indirect effect as controls relating to the operation of the system (for example, selecting a drawing effect from a selection of options by rotating a highlight over a circular list of options to choose the highlighted one, or by rotating the options to choose the one at the 3 o'clock position).

One useful application of this orientation data is an eraser instrument with a non-circular erasing footprint on the drawing surface. Physical erasers tend not to be circular and this facilitates the use of a corner for local erasing or a wide axis for general erasing. This capability can be replicated in digital drawing systems where the orientation of an erasing instrument can be determined and applied similarly.

Angular Coding

When used to discern which blade type is present on the surface, the orientation information can be used to select the optical beams which pass through the area at an angle substantially perpendicular to the blade axis. This axis is well-suited to encoding an identifiable attribute onto the blade. The blade can be manufactured such that the optical transmission through it is somewhat dependent on the angle of the beam relative to the orientation of the blade. This can be accomplished by several approaches such as: (1) apertures (for example, slots) in the blade which form axial channels through the blade which is made from a substantially optically attenuating material; (2) patterns of opaque, diffuse, or refracting regions on one or both wide surfaces of the blade, where the blade is made entirely or partially from an optically transmissive material; (3) patterns of opaque, attenuating, diffuse, or refracting material in isolation or in one or more layers which interact to modulate the degree of optical attenuation; (4) prismatic structures on one or both wide surfaces of the blade, where the blade is made entirely or partially from an optically transmissive material; or (5) any combination of the preceding approaches. An example of a blade with angular coding is one which uses inclined vanes to give directional transmission.

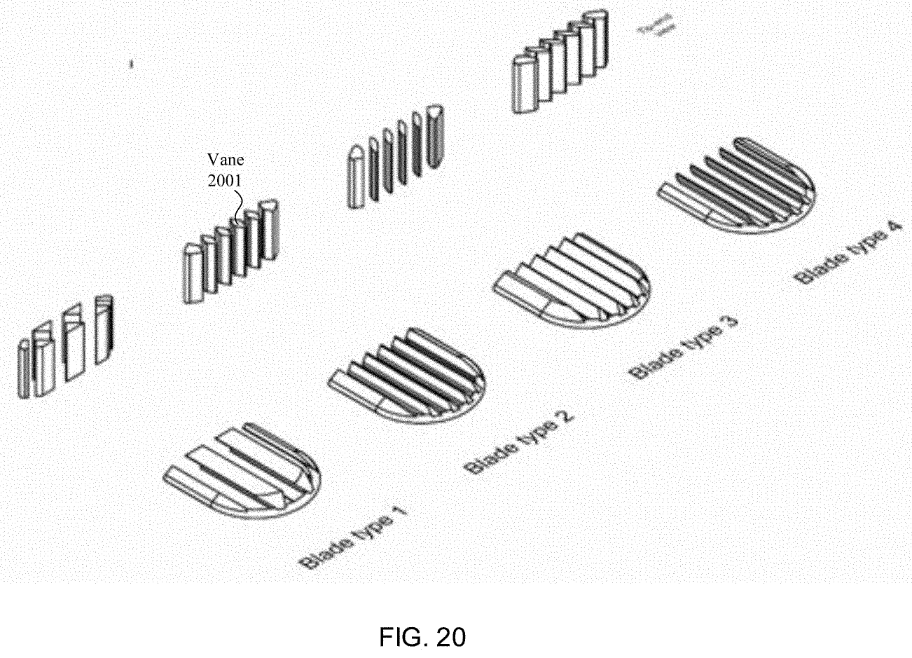

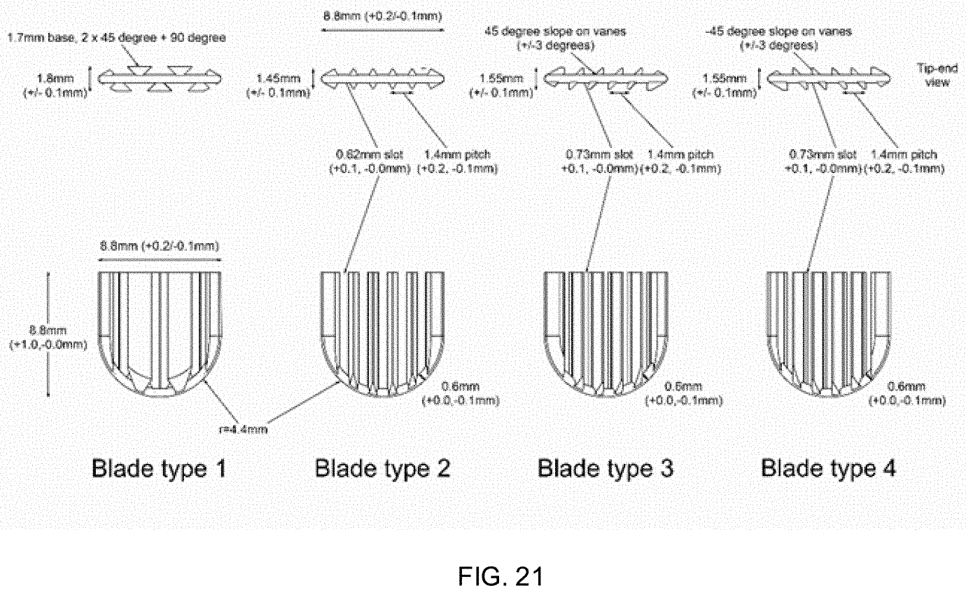

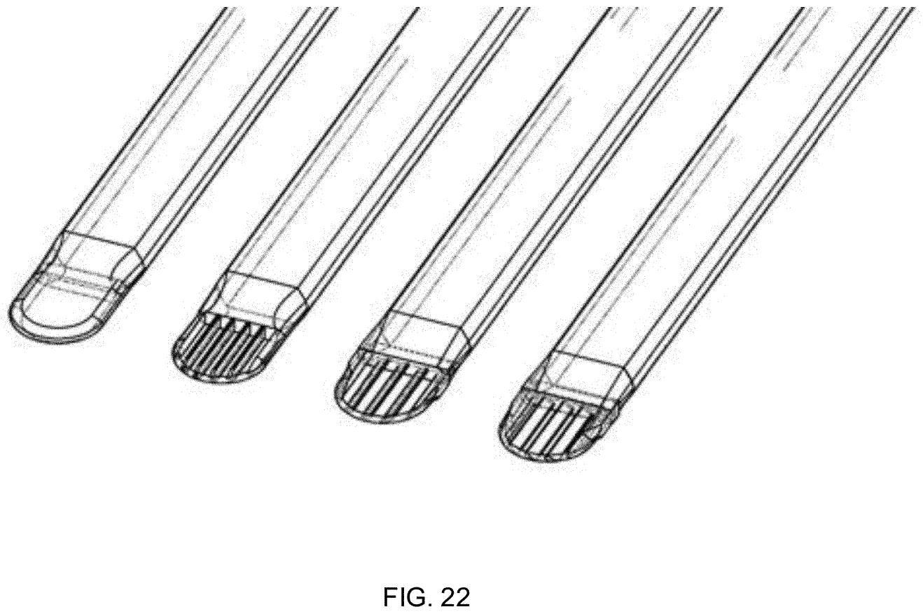

FIGS. 20, 21, and 22 show various examples of different blade designs with angular coding that have different directional transmission properties. Blade designs 1-4 in FIGS. 20-22 include vanes 2001. The vanes 2001 form apertures that allow light to pass through the blade tips. As described below, the shape and orientation of the vanes 2001 may determine the angular coding of the design.

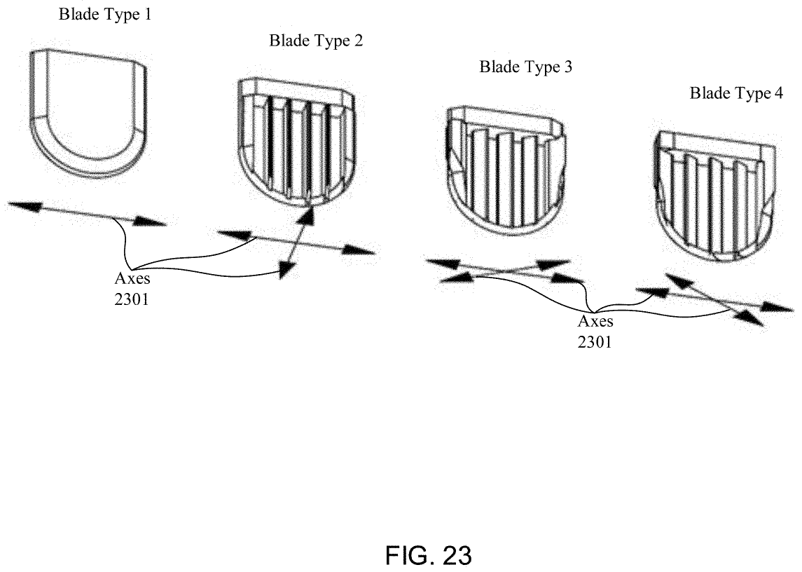

FIG. 23 shows some example blade designs and the primary axes 2301 for which the attenuation is lowest for these designs. Note that the plane of the blade itself offers low attenuation because it is a side-on view. For each of the blade designs shown, the pattern of low attenuation paths is identifiable. It may appear that there is ambiguity between the attenuation patterns for blade 3 and blade 4 in this example set. However, the blades can be designed such that the side-on (+90/−90 degree) profile results in an attenuation value which is lower or higher than the attenuation seen in the least attenuating part of the vaned pattern. An additional way in which the side-on reference angle can be detected by analyzing the beam data is that it is a relatively narrow trough in the polar plot (it is at wrapped around at +90 to −90 degrees, so joining these two parts of the plot gives a rather narrow ‘v’, narrower than any of the other troughs in the plots, which means it can be identified and separated from the other troughs). Having identified the axis associated with the side-on view of the blade, the polar plots for blades 3 and 4 can be differentiated.

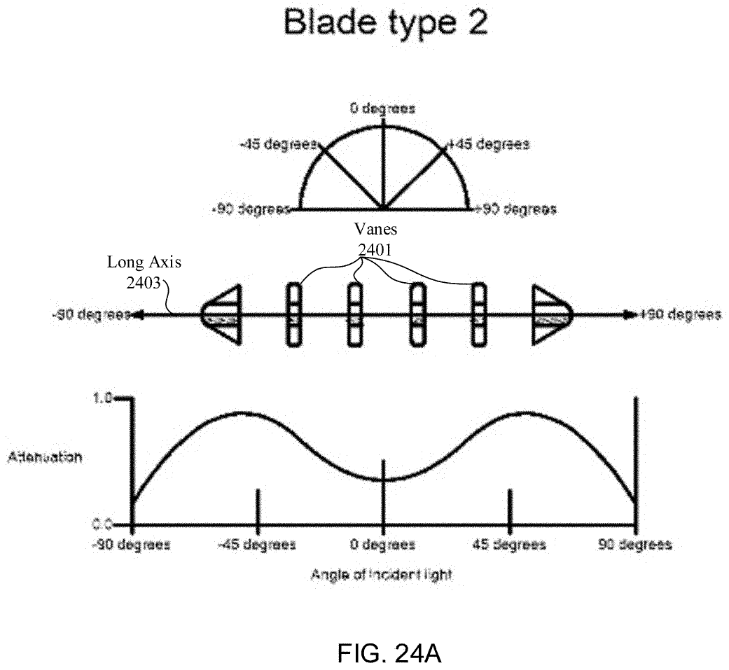

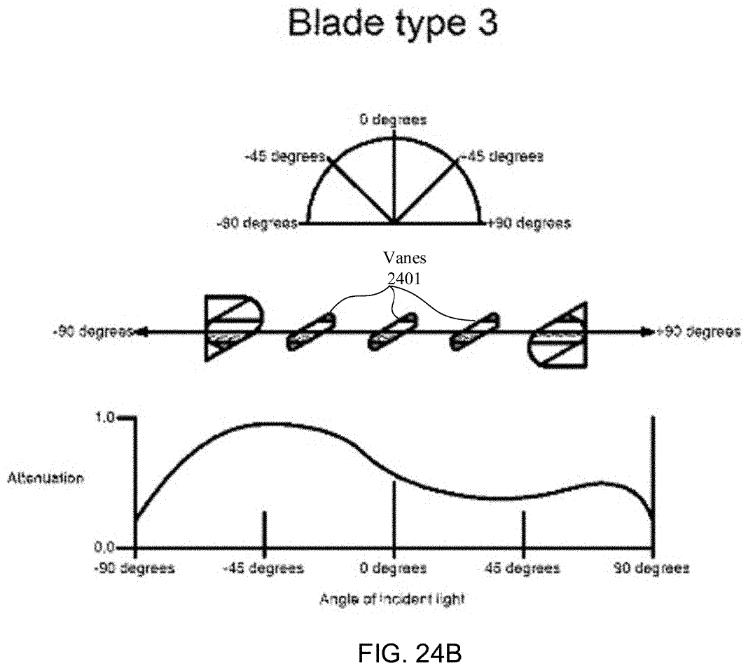

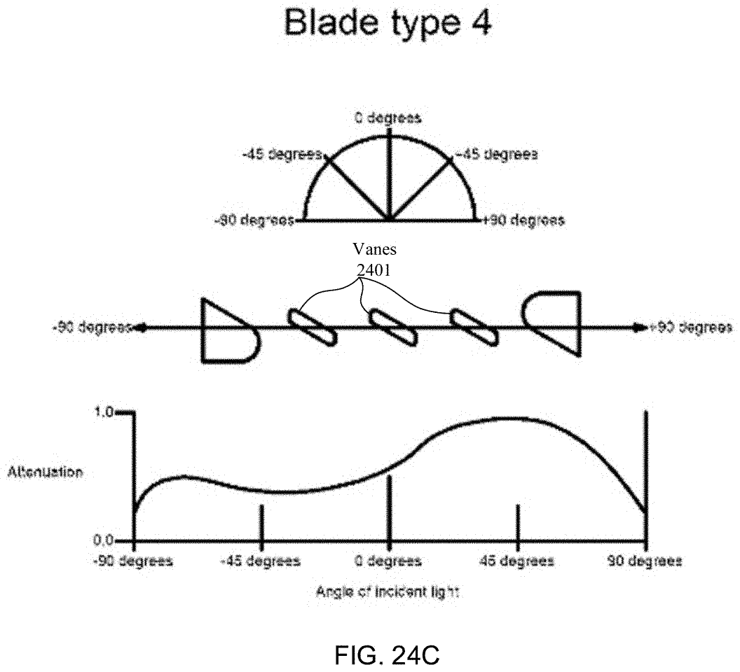

FIGS. 24A-24C show the polar plots for a few example blade designs. It can be seen that the side-on view of a blade (at −90/+90 degrees in each case) is a narrow ‘v’. In the case of these example designs, the +/−90 degree attenuation value is lower than anywhere else in the plot, allowing it to be identified.

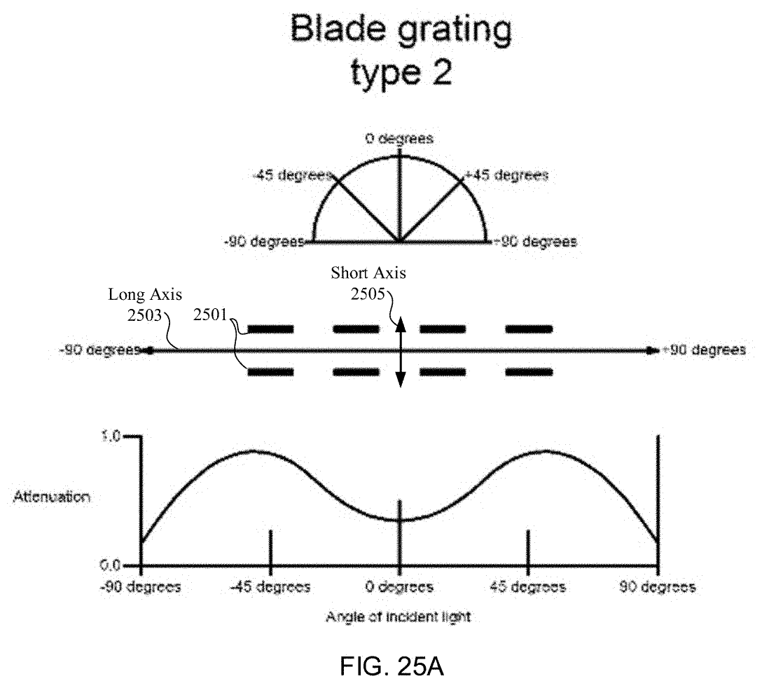

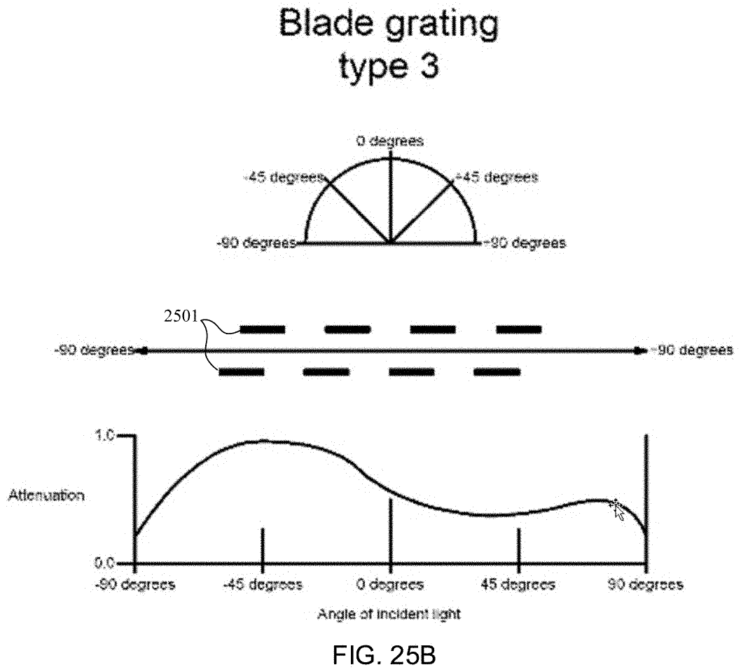

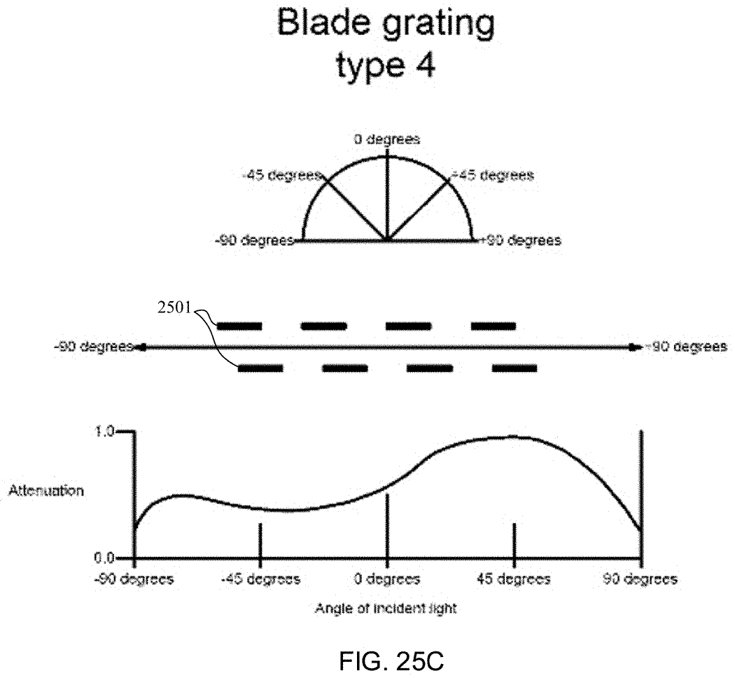

FIGS. 24A-24C also show cross-sections of the example blade designs. The cross-sections are in a plane perpendicular to the long axis of the instrument body. Since the tip designs are blades, the cross-sections include a long axis 2403 and a short axis perpendicular to the long axis 2403. The cross-sections show the orientation of vanes 2401 of the blade design. In FIG. 24A, the vanes are perpendicular to the long axis 2403. In FIGS. 24B and 24C, the vanes are oriented at an angle (e.g., 45 degrees) relative to the short axis. In some embodiments, the vanes may be between 10 and 80 degrees relative to the short axis. In other embodiments (e.g., FIGS. 25A-25C), the vanes are parallel to the long axis. Other configurations of the vanes are possible, including different vanes having different angles relative to the long axis 2403 and short axis.

FIGS. 25A-25C show how similar angular behavior can be achieved with a different construction: spaced layers 2501 of opaque, attenuating, diffusing, or reflective material or structures where the combination of layers 2501 results in a variation in attenuation with azimuth angle of incident light. In the examples shown, there is a section drawing of striped patterns offset between the layers 2501 such that there are angles at which light can pass through with less attenuation than at other angles. In these examples, the pattern layers 2501 are air spaced. In some embodiments, the layers 2501 are aligned with the long axis 2503 and separated along the short axis 2505. Each pair of layers along the short axis 2505 include a pattern of optical structures that interact with incident beams, where an alignment between the layers causes the tip to interact with beams differently depending on their incident angle.

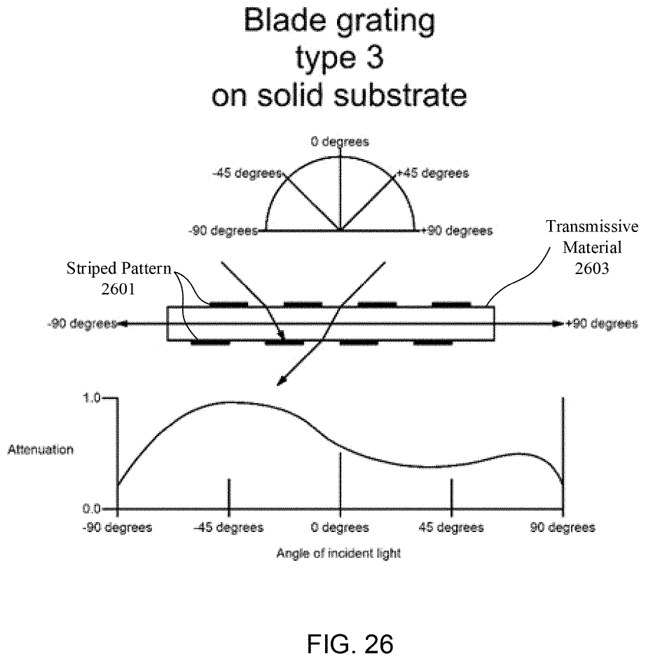

FIG. 26 shows a related scheme where the patterning 2601 is present on the surface of a solid optically transmissive material 2603. The resulting plot is similar to the air-spaced one, but it can be seen in the figure that refraction occurs as light enters and exits the transmissive substrate material. The pattern designs can be adjusted accordingly, and this typically means using smaller pattern elements with smaller gaps between them (because the angle of light in the material will be smaller than in air). For example, light entering a PMMA substrate at an incident angle of 45 degrees in air would be refracted to approximately 28.5 degrees in the PMMA. The tangent of 28.5 degrees is 0.5436 and this is the scaling value that can be used to adjust a design which is intended to have attenuating or transmissive paths as 45 degrees in air for use with PMMA.

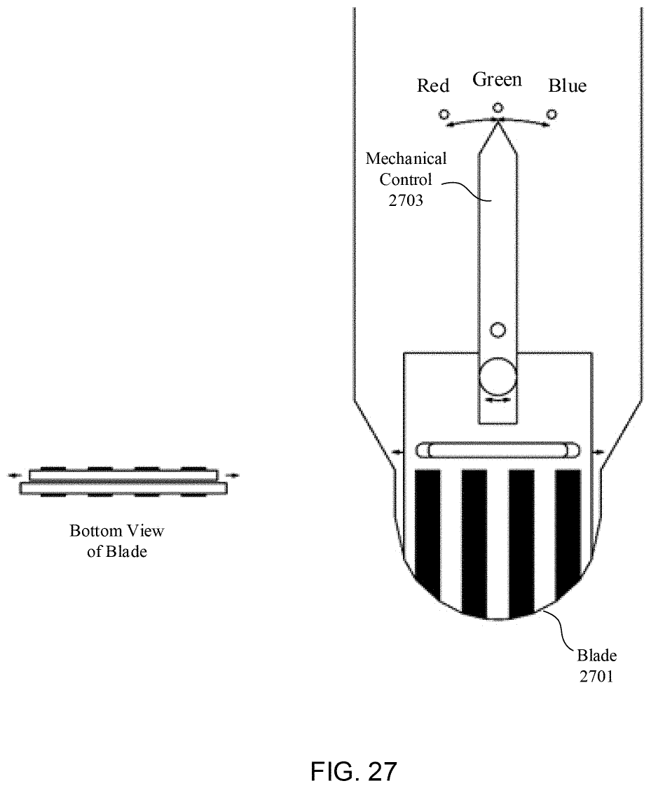

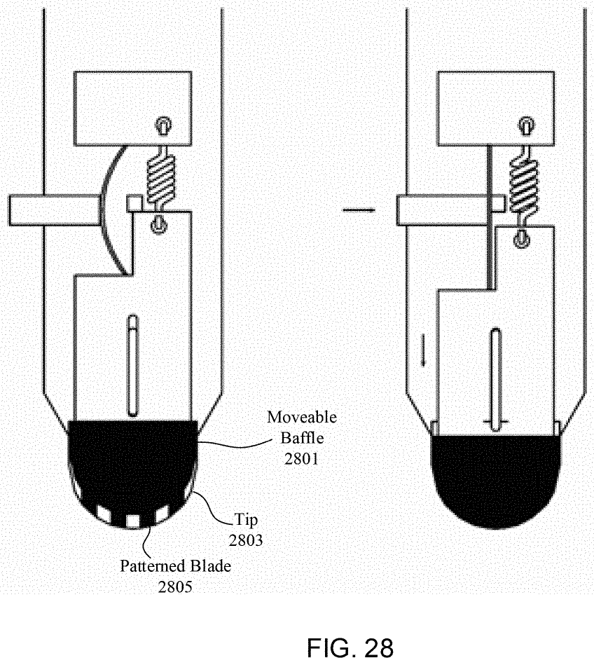

FIG. 27 shows how the angular response of the blade can be adjusted mechanically by separating the patterned layers and moving them relative to one another to form various alignments which can be detected by analysis of the polar response of the blade. An example embodiment is shown of a pen with a blade constructed from two patterned layers, one of which is moveable relative to the other such that the offset between the layers can be detected by analysis of the polar response of the blade and can be set by the user by means of a simple mechanical control 2703. In this case, the control settings are marked to indicate the digital ink color to be selected for the pen (e.g., red, green, or blue).

Alternatively, a button on the pen can be used to change the grating offset such that the sensing system can determine that the polar response of the blade has been changed and that the button is pressed, and to what degree it has been pushed.

FIG. 28 shows a button-operated mechanism on a pen, moving a baffle 2801 over the patterned area of a tip 2803 to conceal it. This results in the polar response of the blade 2805 becoming that of the baffle. Analysis of the polar response allows detection of the button press when the pen is in contact with the touch surface.

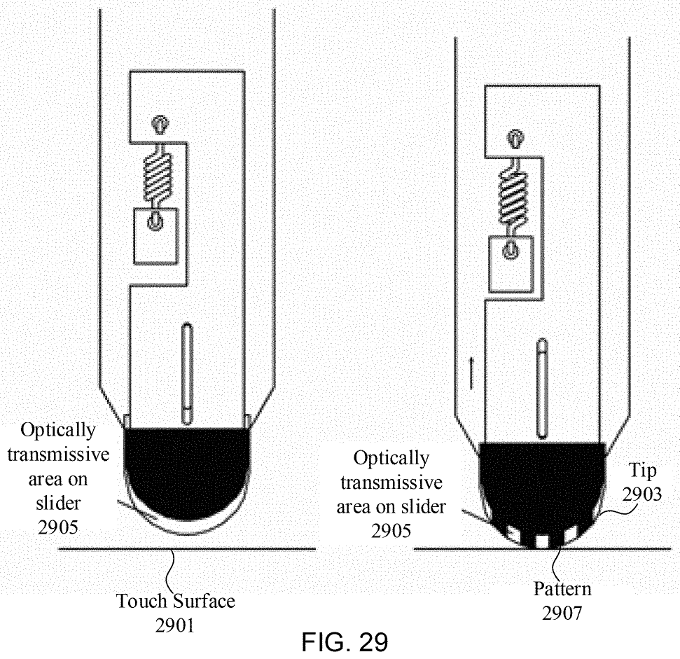

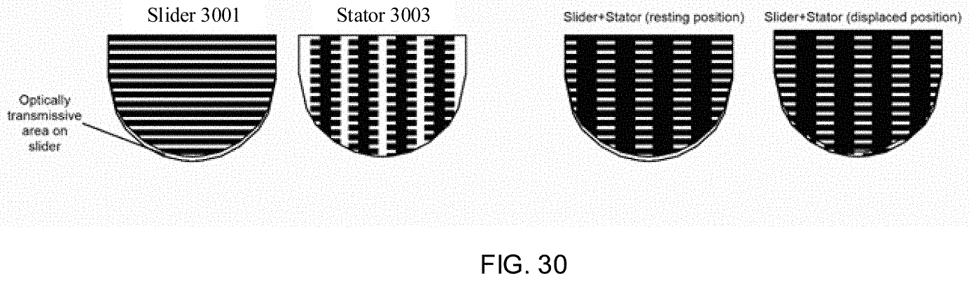

FIG. 29 shows a contact force operated mechanism which causes an optically transmissive area on a slider 2905 to reveal a pattern 2907 behind when the slider tip 2903 is brought into contact with a touch surface 2901. This allows the detection of physical contact between the tip 2903 and the surface 2901. The amount of the pattern 2907 exposed allows a continuous measure of the displacement of the slider, indicating the force applied to the tip 2903. The progressive exposure of the patterned region 2907 is detectable in the polar response for the blade as increased depth of modulation in the polar response (increased variation of attenuation with angle).

FIG. 30 shows an alternative version of the design in FIG. 29 that has patterning. Displacement of the slider 3001 relative to the stator 3003 (e.g., effected by pressing a button or pushing the tip against a touch surface) causes an alternation between at least two patterns. These may take effect on their own, for example each can have a different attenuating value, or may be combined with one or more patterns to give rise to various polar responses as already described.

An alternative mechanism for causing a detectable change in polar response is to change the cross-section of the tip when a mechanical force is applied. This can be done by directly deforming the tip under force, for example by constructing the tip from a compliant material such as a foam. The compliant material deforms under the applied force causing a change in the polar response seen by the sensor. The circularity of the tip may change in response to an applied force, for example by having one cross-section of the tip defined by a rigid material which does not change with applied force and a second cross-section of the tip defined by a compliant material which does change with an applied force. When no force is applied (for example, the tip is not in contact with a surface), the foam at rest defines a cross-section which is similar to that of the rigid cross-section which can be at right-angles to the compliant section. The result is a substantially constant cross-section corresponding polar response. When brought into contact with a surface, the compliant section enlarges laterally under vertical compression causing the polar response to be less circular, having a peak in the polar response where the compliant section has expanded.

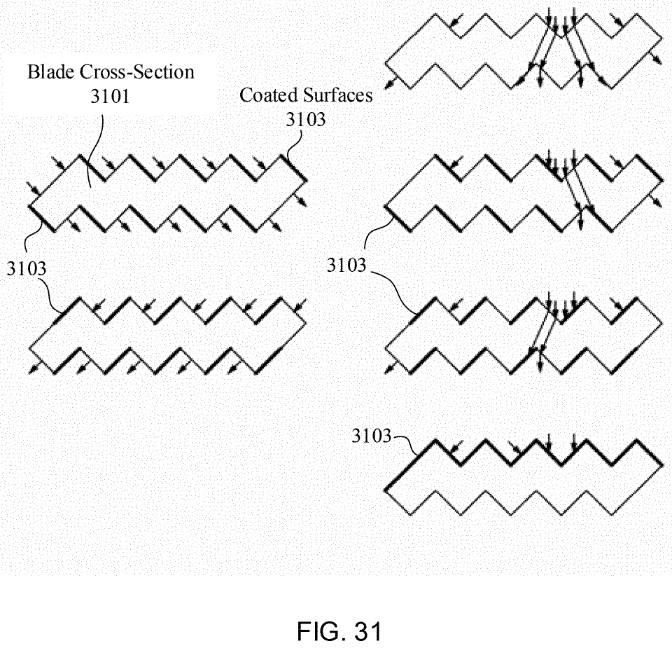

FIG. 31 shows a cross-section of a blade 3101 made from a substantially optically transmissive material. Light incident on a blade of this design shows a polar response that can be configured by changing the detail of the inclined surfaces. For example, the inclined surfaces can be selectively painted or coated 3103. The surfaces can also be designed to be uneven, an approach which is particularly suitable for injection molding. The uneven or coated surfaces 3102 diffuse or absorb light such that it does pass through the blade (or is at least substantially attenuated). The uneven or coated surfaces 3102 are shown as thick lines in the figure. However, light incident on the blade at a normal to an uncoated and flat surface passes through efficiently, typically with just a small loss owing to Fresnel reflections at the surfaces. This can be seen on the left side of FIG. 31. The surfaces shown are inclined at 45 degrees, but other angles may be used. The right side of FIG. 31 shows example paths for incident light at various angles on four different structures. The top design transmits light to some degree at all incident angles shown. It can be seen that some of the light incident at 0 degrees (vertical as drawn) exits at a substantially refracted angle whereas other vertically incident light passes through with only a slight offset. The highly refracted light is effectively lost from the system. The ratio of light transmitted to the light lost in this way can be adjusted by varying the thickness of the material in the blade. A thinner design is more transmissive to light incident at zero degrees in this example.

By adjusting the thickness and the texturing or coating of the surfaces in this design, several different polar responses can be achieved. One advantage of this approach may be the depth of the modulation. Where gratings and other obscuring designs typically offer approximately 50% transmission (e.g., at best), this design can achieve up to 90% transmission at favorable angles of incidence.

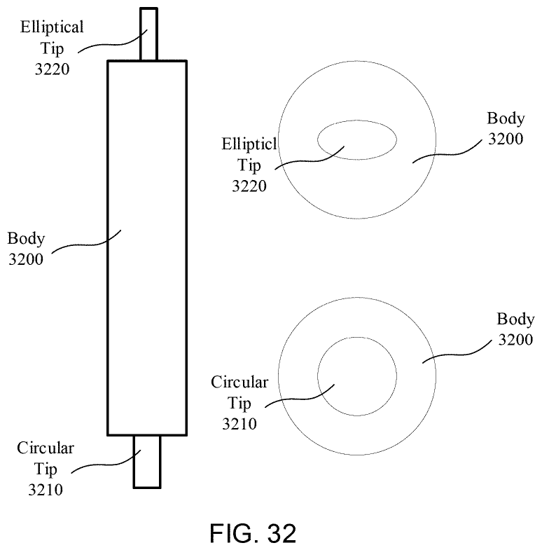

FIG. 32 illustrates an embodiment of an instrument that has a body 3200 and a tip on each end of the body. In the embodiment shown, one of the tips 3210 has a circular cross-section and the other tip 3220 has an elliptical cross-section. Thus, which tip is contacting a touch sensitive surface may be determined based on the differences in beam attenuation that result from each tip. It should be appreciated that any combination of tip designs may be included on each end of the body 3200 giving a wide variety of possible instruments.

Combinations of all of the above methods can be used to provide a variety of differentiable instruments and modal behaviors.

The beam analysis methods described above (e.g., determining a polar response, determining an orientation of a pen instrument based on beam values, etc.) may be performed by the controller 110 and/or the touch event processor 140.

### V. Applications

The touch-sensitive devices and methods described above can be used in various applications. Touch-sensitive displays are one class of application. This includes displays for tablets, laptops, desktops, gaming consoles, smart phones and other types of compute devices. It also includes displays for TVs, digital signage, public information, whiteboards, e-readers and other types of good resolution displays. However, they can also be used on smaller or lower resolution displays: simpler cell phones, user controls (photocopier controls, printer controls, control of appliances, etc.). These touch-sensitive devices can also be used in applications other than displays. The “surface” over which the touches are detected could be a passive element, such as a printed image or simply some hard surface. This application could be used as a user interface, similar to a trackball or mouse.

### VI. Additional Considerations

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation, and details of the method and apparatus disclosed herein.

What is claimed is:

1. A touch-sensitive system comprising:
a touch-sensitive surface;
one or more emitters configured to emit optical beams that traverse the touch-sensitive surface, the optical beams including a first beam that traverses the touch-sensitive surface at a first angle and a second beam that traverses the touch-sensitive surface at a second angle;
a passive instrument configured to interact with the first beam differently than the second beam, wherein the difference in interaction is a function of the first and second angles;
one or more detectors configured to measure one or more properties of the optical beams after the optical beams have traversed the touch-sensitive surface; and
a controller configured to:
determine differences in the properties of the first and second optical beams relative to a scenario where the passive-instrument is not present; and
identify the passive instrument as being one of a set of possible passive instruments based on the differences in the properties of the first and second optical beams.

2. The touch-sensitive system of claim 1, wherein the controller is further configured to determine an orientation of the passive instrument based on the differences in the properties of the first and second optical beams.

3. The touch-sensitive system of claim 2, wherein the controller is further configured to modify a software parameter based on changes in the orientation of the passive instrument.

4. The touch-sensitive system of claim 1, wherein the emitters and detectors are arranged around a periphery of the touch-sensitive surface.

5. The touch-sensitive system of claim 1, wherein the touch-sensitive surface is a plane and the first and second angles are in the plane of the touch-sensitive surface

6. A instrument for use with a touch-sensitive surface, the touch-sensitive surface having emitters that generate optical beams that propagate along the surface to detectors, the passive instrument comprising:
a body having a first end; and
a passive tip, coupled to the first end of the body, and configured to interact with a first optical beam incident on the tip at a first angle differently than a second optical beam incident on the tip at a second angle such that a controller associated with the touch-sensitive surface can distinguish between the tip and a different tip based on properties of the first and second optical beams detected by the detectors.

7. The passive instrument of claim 6, wherein the body has a long axis connecting the first end and a second end, the passive instrument further comprising the different tip coupled to the second end of the body.

8. The passive instrument of claim 6, wherein the tip attenuates the first beam by a greater amount than the second beam.

9. The passive instrument of claim 8, wherein the body has a long axis connecting the first end and a second end, and the tip has an elliptical cross-section in a plane perpendicular to the long axis.

10. The passive instrument of claim 8, wherein the tip includes an aperture configured to allow a portion of the second optical beam to pass through the tip without interacting with the tip.

11. The passive instrument of claim 8, wherein the tip has a cross-section in a plane perpendicular to the long axis of the body, the cross-section having a first axis and a second axis, and the cross-section is narrower along the second axis than the first axis.

12. The passive instrument of claim 11, wherein the tip includes a plurality of vanes arranged along the first axis, the vanes having a wide axis and a narrow axis in the plane perpendicular to the long axis of the body, wherein the wide axis is parallel to the second axis.

13. The passive instrument of claim 11, wherein the tip includes a plurality of vanes arranged along the first axis, the vanes having a wide axis and a narrow axis in the plane perpendicular to the long axis of the body, wherein the wide axis is at an angle between ten and eighty degrees relative to the second axis.

14. The passive instrument of claim 11, wherein the tip includes a pair of layers aligned with the first axis and separated along the second axis, each of the pair of layers including a pattern of optical structures that interact with incident beams, wherein an alignment between the patterns of optical structures of the layers causes the tip to interact with the first beam differently than the second beam.

15. The passive instrument of claim 14, further comprising a mechanical control mounted on the body, the mechanical control, when actuated, causing the alignment between the patterns of optical structures of the layers to change.

16. The passive instrument of claim 6, wherein the tip comprises a pattern of optical elements that cause the tip to interact with the first beam differently than the second beam, the passive instrument further comprising:
a mechanical control mounted on the body; and
a baffled configured to move to at least partially obscure the pattern of optical elements responsive to actuation of the mechanical control.

17. The passive instrument of claim 6, wherein the tip comprises a pattern of optical elements that cause the tip to interact with the first beam differently than the second beam, and the passive instrument further comprises a sliding element configured to obscure the pattern of optical structures when the passive instrument is not in contact with the touch-sensitive surface and reveal at least a portion of the pattern of optical structures when the passive instrument is in contact with the touch-sensitive surface.

18. The passive instrument of claim 17, wherein a proportion of the pattern of optical structures revealed is responsive to a contact force between the tip and the touch-sensitive surface.

19. The passive instrument of claim 6, wherein the tip is configured to diffuse at least some of the optical beams such that an optical intensity measured by some of the detectors increases and the optical intensity measured by others of the detectors decreases, relative to the scenario where the passive instrument is not present.

20. The passive instrument of claim 6, wherein the tip includes a retroreflective portion configured to reflect incident beams with a range of incidence angles at a predetermined reflected angle.
